(19) United States
(12) Patent Application Publication
(10) Pub. No.: US 2021/0049687 A1
(43) Pub. Date: Feb. 18, 2021

(54) SYSTEMS AND METHODS OF GENERATING RESOURCE ALLOCATION INSIGHTS BASED ON DATASETS

(71) Applicant: ROYAL BANK OF CANADA, Toronto (CA)

(72) Inventors: Abdul Rahman ABU LIBDA, Toronto (CA); Haiyang JIANG, Toronto (CA); Parth CHAMPANERI, Toronto (CA); Ling Yan ZHANG, Toronto (CA); Abdulrahman AL-LAHHAM, Milton (CA); Ananya ROY, Toronto (CA); Menglan ZHOU, Markham (CA)

(21) Appl. No.: 16/994,238

(22) Filed: Aug. 14, 2020

Related U.S. Application Data
(60) Provisional application No. 62/886,623, filed on Aug. 14, 2019.

(51) Int. Cl. G06Q 40/02; G06F 16/245; G06N 20/00

(52) U.S. Cl. CPC G06Q 40/025; G06N 20/00; G06F 16/245

(57) ABSTRACT

Machine learning architecture for resource allocation. A system comprising: a processor; a memory coupled to the processor. The memory stores processor-executable instructions that, when executed, configure the processor to: receive a resource allocation query including target data associated with a plurality of feature attributes related to generating a resource allocation prediction; generate the resource allocation prediction based on an allocation model and the target data, the allocation model defined by at least one conditional distribution representation for providing an interim prediction corresponding to one or more feature attributes, and wherein the resource allocation prediction is generated based on a combination of conditional distribution representations respectively correlated with other conditional distribution representations by a hierarchical relation; and transmit a signal representing the resource allocation prediction for display on a user interface.

### CROSS REFERENCE TO RELATED APPLICATIONS

This application claims priority from U.S. provisional patent application No. 62/886,623, entitled “SYSTEMS AND METHODS OF GENERATING RESOURCE ALLOCATION INSIGHTS BASED ON DATASETS”, filed on Aug. 14, 2019, the entire contents of which are hereby incorporated by reference herein.

### FIELD

Embodiments of the present disclosure generally relate to machine learning, and in particular to systems and methods of machine learning architecture for resource allocation.

### BACKGROUND

A computing server may allocate resources to one or more client devices associated with entities. Resources may include assets (e.g., tokens, currency, precious metals), computing resources, or the like. The computing server may allocate resources based on one or more allocation criteria. As an illustrating example, resources may include currency that may be loaned (e.g., loaning money as part of a mortgage loan). A computing server associated with a lending institution may adjudicate a mortgage loan application for providing an approve or decline application result based on historical mortgage loan application data. The historical mortgage loan application data may be based on a plurality data attributes, such as credit score data, annual income data, location data, occupation data and associated occupation industry, or the like.

The computing server may receive large volumes of datasets representing historical resource allocation data, analyze the large volumes of datasets based on the one or more allocation criteria, and determine whether to allocate resources to an entity. The computing server may determine whether to allocate resources based on rules-based or other types of models and provide an output value associated with whether to or what quantity of resources to allocate.

### SUMMARY

The present disclosure describes systems and methods of resource allocation events based on machine learning architectures. In some embodiments of the present disclosure, resources may include currency, digital assets, precious metals, computing resources, or other types of assets. In some scenarios, resource allocation events may include resource loans based on adjudicated credit applications. Example resource loans may include asset-secured loans (e.g., mortgage loans), unsecured loans (e.g., credit card or line-of-credit accounts), computing resource loans (e.g., cloud computing services), or the like. In some scenarios, a computing server may be configured to conduct operations to evaluate resource allocation queries or loan applications (e.g., mortgage loan applications) based on historical resource loan allocation data and provide a loan application result which may include approve, deny, or re-submit based on conditions.

As a non-limiting example, operations for adjudicating a mortgage loan application may include analysis of a data record associated with a potential resource borrower (e.g., mortgagee) based on historical mortgage loan application datasets. The data record associated with the potential resource borrower may include data values associated with data attributes or feature attributes. In some implementations, operations for adjudicating a mortgage loan application may include operations for conducting comparative analysis on data values associated with particular feature attributes (e.g., mortgagee credit score value, annual income value, etc.) with data values of those particular feature attributes in historical mortgage loan applications, and for providing a prediction on whether the example mortgage loan application should be approved.

Computing operations for adjudicating a resource allocation application may be heavily dependent on prior domain knowledge based historical mortgage loan application datasets. In some situations, a computer server may not be provided with comprehensive prior domain knowledge. For example, a historical mortgage loan application dataset may not include a sufficient sample set or size of mortgage applications for real estate property in a rural city, or may not include a sufficient sample of mortgage applications by a potential mortgagee having a particular occupation. Where a computing server may not include a sufficient historical dataset for one or more feature attributes, it may be challenging for a computing server to adjudicate resource allocation applications based on partial datasets with desired granularity or precision.

In some situations, it may be challenging for a computer server to adjudicate resource allocation applications that may be incomplete or missing data values associated with feature attributes relevant to adjudicating the resource allocation application. For instance, a particular mortgage loan application may not provide a mortgagee's occupation, the mortgagee's annual salary, or details of the real estate property proposed to for purchase. It may be beneficial to provide systems and methods for machine learning architecture for providing resource allocation predictions in spite of incomplete or unrepresentative datasets.

Embodiment systems described in the present disclosure include machine learning architectures that may encode historical resource location datasets based on feature attribute subgroups and generate conditional distribution representations of the feature attribute subgroups. Example conditional distribution representations may include one or more of Bernoulli distribution functions, Gaussian distribution functions, Dirichlet distribution functions, or other distribution functions that may model or represent feature attributes. In embodiments of the present disclosure, conditional distribution representations may represent a range of probabilities of output for a corresponding range of possible output values.

The conditional distribution representations may be defined by parameters or coefficients determined by training operations based on training datasets and evaluation datasets. Training or evaluation datasets may be provided by historical resource allocation datasets. As a non-limiting example, historical resource allocation datasets may include datasets representing historical mortgage applications and feature attributes associated with the historical mortgage applications (e.g., application decision, applicant's credit score, applicant's annual income, applicant's location, real estate property type, etc.).

In some embodiments, the machine learning architecture includes identifying feature attributes that may be characterized by a hierarchical relation with other feature attributes. In some embodiments, hierarchical relations may correspond to genus and species type relations. For example, a feature attribute directed to a Location-Country may be hierarchically related to a Location-Province or a Location-City. As will be described in the present disclosure, by providing a machine learning architecture that segments dataset feature attributes according to hierarchical relations, generated prediction models may be configured to provide resource allocation predictions in spite of dataset deficiencies in prior domain knowledge or historical resource allocation datasets, or data value deficiencies in a resource allocation query (e.g., a mortgage application).

Embodiment systems described in the present disclosure for machine learning architecture may associate conditional distribution representations with respective feature attributes that are hierarchically related, such that resource allocation predictions may be provided in spite of partial, unavailable, or unrepresentative samples of data.

As a non-limiting example, a conditional distribution representation may be associated with the data attributes: Location-Province and Location-City. The Location-Province may be Ontario and the Location-City may be Barrie. In some scenarios, a historical resource allocation dataset may not include a sufficiently large number of data records associated with mortgages for properties or for mortgagees located in Barrie. When the number of data records representative of mortgages approved/declined for properties in Barrie may be relatively small, resource allocation predictions may not be provided with required confidence. As Barrie is a city in the Province of Ontario and as conditional distributions may also be associated with the data attribute Location-Province, in some embodiments, the resource allocation predictions may also be based, at least in part, on conditional distribution representations associated with the Province of Ontario for a particular mortgage application.

As data attributes may be hierarchically related to other data attributes, in some embodiments, conditional distribution representations may be refined or updated based on additional historical datasets generated over time. In the above-described example relating to data attributes for location data, although a conditional distribution representation associated with the City of Barrie (Location-City) may take into account conditional distribution representation associated with Ontario (Location-Province) due at least to an insufficient sample size of datasets associated with the City of Barrie, the conditional distribution representation associated with the City of Barrie may be refined or updated over time during periodic prediction model training with new historical datasets having data attributes relating to the City of Barrie.

In some embodiments, systems for machine learning architecture described herein may provide signals for representing an explanation representation based on a conditional distribution representation associated with one or more data attributes. In an example where, a conditional distribution representation associated with the feature attributes “Salary” and “Credit Score” may be a Gaussian distribution, systems may be configured to provide an explanation representation indicating a percentage confidence value that a mortgage application with a particular salary data value and a credit score data value may be approved. Other examples may be contemplated.

In one aspect, the present disclosure provides a system that may include: a processor; and a memory coupled to the processor. The memory may store processor-executable instructions that, when executed, configure the processor to: receive a resource allocation query including target data associated with a plurality of feature attributes related to generating a resource allocation prediction; generate the resource allocation prediction based on an allocation model and the target data, the allocation model defined by at least one conditional distribution representation for providing an interim prediction corresponding to one or more feature attributes, and wherein the resource allocation prediction is generated based on a combination of conditional distribution representations respectively correlated with other conditional distribution representations by a hierarchical relation; and transmit a signal representing the resource allocation prediction for display on a user interface.

In another aspect, the present disclosure provides a method that may include: receiving a resource allocation query including target data associated with a plurality of feature attributes related to generating a resource allocation prediction; generating the resource allocation prediction based on an allocation model and the target data, the allocation model defined by at least one conditional distribution representation for providing an interim prediction corresponding to one or more feature attributes, and wherein the resource allocation prediction is generated based on a combination of conditional distribution representations respectively correlated with other conditional distribution representations by a hierarchical relation; and transmitting a signal representing the resource allocation prediction for display on a user interface

In another aspect, a non-transitory computer-readable medium or media having stored thereon machine interpretable instructions which, when executed by a processor may cause the processor to perform one or more methods described herein.

In various aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a system, in accordance with an embodiment of the present disclosure;

FIG. 2 illustrates a flowchart illustrating data flow and data operations for providing resource allocation predictions, in accordance with an embodiment of the present disclosure;

FIG. 3 illustrates a sample of a prepared dataset, in accordance with an embodiment of the present disclosure;

FIG. 4 illustrates a representation of a data structure, in accordance with an embodiment of the present disclosure;

FIG. 5 illustrates a directed graph structure associated with a prepared dataset, in accordance with an embodiment of the present disclosure;

FIG. 6 illustrates a sample of a prepared dataset, in accordance with an embodiment of the present disclosure;

FIGS. 7, 8, 9, and 10 illustrate a comparisons of a “prior” conditional distribution representation and a “posterior” conditional distribution representation based on increasing number of data records provided to a machine learning architecture, in accordance with embodiments of the present disclosure;

FIG. 11 illustrates an architecture diagram of a resource allocation model, in accordance with an embodiment of the present disclosure;

FIG. 12 illustrates a flowchart of a method of training a resource allocation model, in accordance with an embodiment of the present disclosure;

FIG. 13 illustrates a flowchart of a method of machine learning architecture for resource allocation, in accordance with an embodiment of the present disclosure;

FIG. 14 illustrates a portion of a graphical user interface providing resource allocation predictions, in accordance with an embodiment of the present disclosure;

FIG. 15 illustrates a portion of a graphical user interface providing resource allocation predictions, in accordance with an embodiment of the present disclosure;

FIG. 16 illustrates a portion of a graphical user interface providing interface elements associated with interpretability of resource prediction results, in accordance with an embodiment of the present disclosure;

FIG. 17 illustrates portions of a graphical user interface providing interface elements associated with interpretability of resource prediction results, in accordance with an embodiment of the present disclosure;

FIG. 18 illustrates a graphical user interface providing summary details of a resource allocation query, in accordance with an embodiment of the present disclosure;

FIG. 19 illustrates a graphical user interface providing summary details of a resource allocation query, in accordance with an embodiment of the present disclosure; and

FIG. 20 illustrates a graphical user interface providing summary details of a resource allocation query, in accordance with an embodiment of the present disclosure.

### DETAILED DESCRIPTION

Systems and methods of predicting resource allocation events based on multi-dimensional datasets or a multi-featured datasets are described in the present disclosure. In some embodiments, the systems and methods of predicting resource allocation events may provide explanatory output associated with the predicted resource allocation event. For example, the explanatory output may include a user interface output signal representing a confidence value associated with the resource allocation event prediction. Other types of explanatory output associated with the resource allocation prediction will be described in the present disclosure.

To illustrate embodiments of the present disclosure, example banking institution systems and methods may be described. In the context of banking institution systems, resource allocations may include allocating resources to a client device associated with a banking customer. For example, resource allocations may include approving a mortgage loan or allocating resources (e.g., currency) to a banking customer. Other types of resources allocations or resources may be contemplated. For example, resource allocations may include approving a credit card credit limit for a banking customer or allocating monetary funds associated with a personal line-of-credit account associated with the banking customer. In some other examples, resources may include precious metals, computing resources, or other types of resources. In some embodiments, systems and methods of generating resource allocation event predictions in other types of systems or environment processes may be contemplated. For example, embodiment systems may allocate computing resources to one or more client devices in the form of cloud computing services based on resource allocation criteria, such as shared resource requirements, resource demand duration, or other resource allocation criteria.

Continuing with examples associated with banking institutions, embodiment systems and methods may generate a signal representing a prediction of whether a bank loan application associated with a banking customer may be approved or declined. The system may receive a data record representing a mortgage application of a banking customer, and the data record may include data fields containing data representing requested resource quantity and evaluative data relevant to predicting whether to approve or deny a bank loan application. The data record may also include data fields associated with a banking customer's occupation, annual salary, credit score, residence location (e.g., country, province/state, city, neighbourhood, etc.), asset values, liability values, or other data fields associated with resource allocation criteria pertinent to evaluating whether to approve or deny a bank loan application. In the present disclosure, such data fields may be referred to as data attributes or feature attributes.

In some examples, banking institution systems and methods may conduct operations based on rules-based models for determining whether to allocate resources and, if allocated, for determining a quantity of resources to allocate to one or more client devices associated with banking customers. Because rules-based models may be based on pre-determined allocation criteria, such resource allocation decisions may be scope limited.

In some examples, banking institution systems and methods may conduct machine learning model operations based on stored datasets for generating a probability measure that resources shall be allocated to the banking customers associated with client devices (e.g., a measure indicating whether to allocate or not to allocate resources). In some scenarios, machine learning models may be trained based on numerous datasets of a plurality of categories. Where particular dataset category may only be represented by a small number of data records, some machine learning models may not be trained to a desired accuracy level. For instance, a system that trains a machine learning model trained with a small number of data records for a particular feature attribute may not generate sufficiently tuned model parameters for providing an accurate output. It may be beneficial to provide systems and methods including prediction models to increase model training accuracy in spite of a relatively small training datasets. In some situations, it may be beneficial to provide systems for machine learning architecture for preparing datasets and encoding prior domain knowledge from prepared datasets to provide interpretive measures associated with resource allocation predictions.

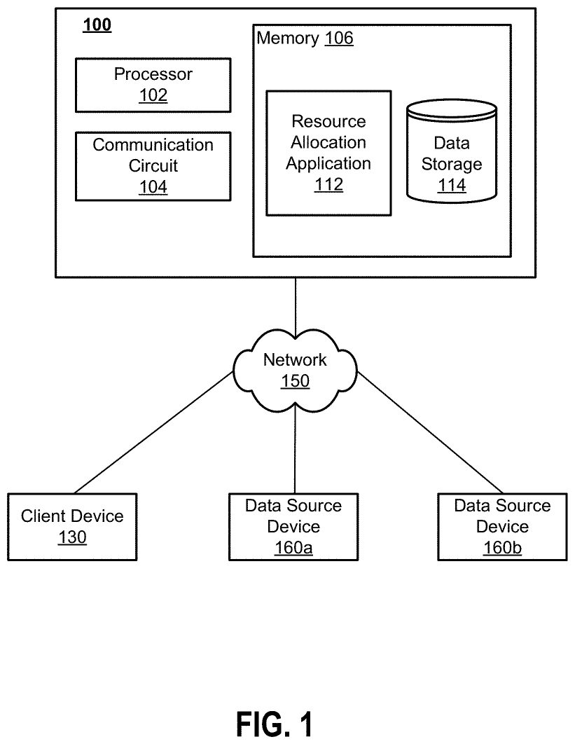

Reference is made to FIG. 1, which illustrates a system 100, in accordance with an embodiment of the present disclosure. The system 100 may transmit or receive data messages via a network 150 to or from a client device 130 or one or more data source devices, such as a first data source device 160a and a second data source device 160b. A sole client device 130 and two data source devices are illustrated in FIG. 1; however, it may be understood that any number of client devices or data source devices may transmit or receive data messages to or from the system 100.

As a non-limiting example, the system 100 being associated with a banking institution and the client device 130 may be associated with banking customers transmitting resource allocation queries (e.g., mortgage loan applications, line-of-credit applications, etc.) to the system 100. In some examples, the system 100 may be configured to determine a resource allocation result (e.g., indication of approval or denial of requested resource allocation and, if approved, resource allocation quantity) and may be configured to transmit the resource allocation result to the client device 130.

In some examples, a client device 130 may be associated with resource adjudicator of the banking institution, such as mortgage loan adjudicators, loan underwriters, or similar entities adjudicating a resource allocation query. In examples of the client device 130 being associated with a mortgage loan adjudicator, the client device 130 may transmit the resource allocation query (e.g., mortgage loan application result prediction: should the mortgage loan request be approved or denied?) to the system 100. The system 100 may be configured to generate a resource allocation prediction (e.g., should the mortgage loan application be approved or denied based on historical mortgage approval results) for transmission to the client device 130. In such examples, a mortgage adjudicator may conduct a preliminary data-driven assessment via machine learning architectures and models described herein prior to conducting more comprehensive adjudication operations. Other operations of the system 100 and the client device 130 may be contemplated and will be described herein.

The network 150 may include a wired or wireless wide area network (WAN), local area network (LAN), a combination thereof, or other networks for carrying telecommunication signals. In some embodiments, network communications may be based on HTTP post requests or TCP connections. Other network communication operations or protocols may be contemplated. In some embodiments, the network 150 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, or other networks, including one or more combination of the networks.

The system 100 includes a processor 102 configured to implement processor-readable instructions that, when executed, configure the processor 102 to conduct operations described herein. For example, the system 100 may be configured to conduct operations associated with resource allocation based on a machine learning architecture or models described herein. In some examples, the processor 102 may be a microprocessor or microcontroller, a digital signal processing processor, an integrated circuit, a field programmable gate array, a reconfigurable processor, or combinations thereof.

The system 100 includes a communication circuit 104 configured to transmit or receive data messages to or from other computing devices, to access or connect to network resources, or to perform other computing applications by connecting to a network (or multiple networks) capable of carrying data.

In some examples, the communication circuit 104 may include one or more busses, interconnects, wires, circuits, or other types of communication circuits. The communication circuit 104 may provide an interface for communicating data between components of a single device or circuit.

The system 100 includes memory 106. The memory 106 may include one or a combination of computer memory, such as random-access memory, read-only memory, electro-optical memory, magneto-optical memory, erasable programmable read-only memory, and electrically-erasable programmable read-only memory, ferroelectric random-access memory, or the like. In some embodiments, the memory 106 may be storage media, such as hard disk drives, solid state drives, optical drives, or other types of memory.

The memory 106 may store a resource allocation application 112 including processor-readable instructions for conducting operations described herein. In some examples, resource allocation application 112 may include operations for generating resource allocation models, training and evaluating resource allocation models, and generating resource allocation predictions based on historical resource allocation datasets encoded based on feature attribute hierarchical relations, as will be detailed in the present disclosure.

The system 100 includes data storage 114. In some embodiments, the data storage 114 may be a secure data store. In some embodiments, the data storage 114 may store data records received from data source devices (160a, 160b), data received from data source devices for populating data records, or other data sets associated with machine learning architecture or resource allocation models.

The client device 130 may be a computing device, such as a mobile smartphone device, a tablet device, a personal computer device, or a thin-client device. The client device 130 may be configured to transmit messages to/from the system 100.

The client device 130 may include a processor, a memory, or a communication interface, similar to the example processor, memory, or communication interfaces of the system 100. In some embodiments, the client device 130 may be a computing device associated with a local area network. The client device 130 may be connected to the local area network and may transmit one or more data sets or signals to the system 100.

The data source devices (160a, 160b) may be computing devices, such as data servers, database devices, or other data storing systems associated with a banking institution. For example, the data source device 160a may be associated with a banking institution providing banking accounts to users. The banking institutions may maintain bank account data sets associated with users of client devices 130, and the bank account data sets may be a record of monetary transactions representing credits (e.g., salary payroll payments, etc.) or debits (e.g., payments from the user's bank account to a vendor's bank account). As non-limiting example, the second data source device 160b may be associated with a database storing employee data records. In some other examples, data source devices may be associated with a database storing data associated information technology malfunction events or data associated with banking system failures. In some examples, the data source devices (160a, 160b) may be associated with a database storing data records associated with past resource allocation results (e.g., datasets representing prior domain knowledge). Other examples of data records may be contemplated.

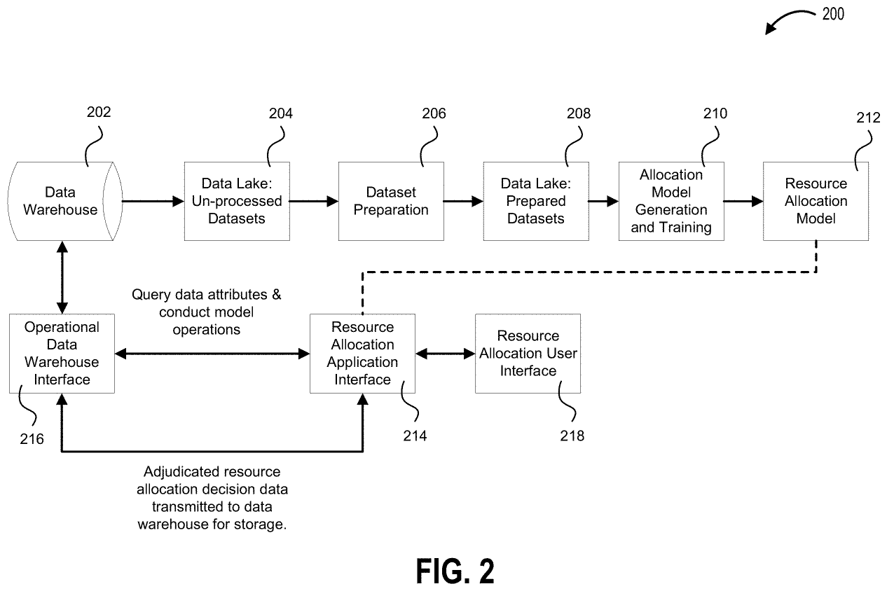

Reference is made to FIG. 2, which is a flowchart illustrating data flow 200 and data operations for providing resource allocation predictions, in accordance with embodiments of the present disclosure. One or more of the computing devices illustrated in FIG. 1 may conduct operations of the data flow 200 depicting data flow.

In some embodiments, the data flow 200 may be associated with data records representing resource allocations. The data flow 200 may include a data warehouse stage 202 storing a plurality of datasets or data records representing past resource allocation data. For example, the data warehouse may include data records representing historical loan applications associated with banking customers. Respective data records of loan applications may include data fields storing loan application results (e.g., approve/decline loan, quantity of loaned resource, etc.), fields storing data representing loan products applied for (e.g., conventional mortgage loans, home-equity line of credit loans, credit card accounts, etc.), credit bureau data (e.g., data representing credit scores, account payment delinquencies, presence of revolving credit accounts, number of credit inquiries in the past 6 months/12 months etc.), financial or employment data of the banking customer (e.g., data representing annual income, asset/liability value, net worth, TDS/GDS ratios, etc.), collateral data (e.g., data representing number and type of collateral, appraisal value, etc.), location data (e.g., address of banking customer, location of real estate property or other secured assets etc.), or other data that may be evaluated, pertinent, or relevant for adjudicating a loan application.

Thus, the data warehouse 202 may include datasets representing prior domain knowledge, and the system 100 (FIG. 1) may conduct operations for evaluating datasets representing prior domain knowledge in combination with evaluating resource allocation queries (e.g., mortgage loan applications), and for generating and training resource allocation models. Embodiments of resource allocation models will be described herein.

The data flow 200 includes a data lake at stage 204 for storing un-processed data sets. The un-processed data sets may be extracted from the data warehouse 202. In some embodiments, the data warehouse 202 or the data lake at stage 204 may be provided by one or more data source devices (160a, 160b). The un-processed datasets may include customer identifying data, client annual income data, or other data associated with banking customers in un-processed format.

The data flow 200 includes operations of a dataset preparation stage 206. The data preparation stage 206 may include operations for concatenating or joining customer identifying data, data associated with resource loan application/queries, loan products being applied for, adjudicated resource allocation decision (e.g., approve/deny), or other data associated with data records. In some embodiments, operations of the dataset preparation stage 206 may include data transformation operations for organizing datasets into tabular form or other desirable formats.

The data flow 200 includes a data lake at stage 208 for storing dataset output from the dataset preparation stage 206. In some examples, the dataset output stored at stage 208 may be a new tabular format with a granular combination of data representing customer data fields associated with resource allocation queries and applications.

The data flow 200 includes resource allocation model generation and training operations at stage 210. The allocation model generation and training operations may be based on model generation operations and model training operations described throughout the present disclosure. The allocation model development operations or the model training operations may be based on dataset output from stage 206. In some examples, the allocation model may be developed based on historical datasets representing prior domain knowledge.

In response to allocation model generation and training operations, the data flow 200 includes operations for generating the resource allocation model at stage 212. In some examples, the resource allocation model may be encoded and provided as a predictive model markup language (PMML) file. In some embodiments, the PMML file representing the resource allocation model may be based on an XML file format, and operations or functions defined therein may be parsed or executed by the system 100 (FIG. 1). In some embodiments, the resource allocation model may include one or more conditional distribution representations defined by datasets representing distributions of a range of predicted outcomes and likelihood of respective range of predicted outcomes. For example, a conditional distribution representation may be a Gaussian distribution, and the Gaussian distribution may represent a range of possible resource allocation values and probabilities of those values. In some scenarios, the Gaussian distribution may be defined by a mean value and a standard variation value. Other file types or structures for encoding the resource allocation model may be contemplated.

In some embodiments, at stage 210 or stage 212, the data flow 200 may include operations to re-train the resource allocation model at periodic intervals for generating updated or revised resource allocation models. In some embodiments, the operations to re-train the resource allocation model at stage 210 may be in response to periodic model performance evaluation data. In some embodiments, operations may be conducted to determine whether accuracy of the resource allocation model may have reached a certain threshold level of accuracy or other benchmark metric for a threshold number of dataset samples. In situations where a system may determine that the accuracy of the resource allocation model may have reached a desirable threshold level of accuracy or other benchmark metric for a threshold number of dataset samples, an updated resource allocation model may be provided for integration with a resource allocation application interface at stage 214.

At stage 214, the data flow 200 includes a resource allocation application interface. In some embodiments, the system 100 may integrate the resource allocation model (from stage 212) with the resource allocation application interface at stage 214.

At stage 214, the resource allocation application interface may be an interface for querying, via a data warehouse application interface (at stage 216), data attributes from the data warehouse (stage 202) and for executing operations defined by the resource allocation model (from stage 212) (e.g., provided via a PMML file). For example, operations defined by the resource allocation model in combination with queried data attributes (via the data warehouse application interface) may generate resource allocation predictions (e.g., approve or decline resource allocation requests) for display at a resource allocation user interface 218. As will be disclosed herein, the generated resource allocation predictions may provide a resource allocation adjudicator (e.g., mortgage application adjudicator or underwriter) with a system-generated preliminary assessment of a resource allocation request (e.g., mortgage loan application) based on a machine learning architecture.

In some embodiments, adjudicated resource allocation decisions (e.g., approve/decline resource allocation requests) may be transmitted, via the data warehouse application interface (at stage 216) as one or more data records for storage at the data warehouse (stage 202). In some embodiments, the adjudicated resource allocation decisions may be based on a decision by the resource allocation adjudicator, such that the adjudicated resource allocation decisions may be concatenated or combined with datasets stored at the data warehouse. Datasets stored at the data warehouse 202 may supplement the prior domain knowledge for future model development, model training, or model execution.

In some embodiments, the data flow 202 includes receiving user input via a resource allocation user interface 218. The resource allocation user interface may be a graphical user interface displayed at a client device 130 (FIG. 1) associated with a resource allocation adjudicator.

In some embodiments, the resource allocation user interface may include user interface elements for displaying (on a client device 130) resource allocation predictions. In some embodiments, the resource allocation user interface 218 may include user interface elements for receiving input from the adjudicator (e.g., inputting request for a resource allocation prediction or inputting desired features) for generating explanations or interpretation data associated with the resource allocation decisions. As will be described in the present disclosure, examples of interpretation data may include identification of data attributes (e.g., annual income level, credit score data, etc.) that are most pertinent to the resource allocation decision and confidence values of resource allocation predictions when data values associated with data attributes are changed. For example, embodiment systems may provide a dynamic user interface that may update with more granular or increasingly accurate/confident resource allocation prediction as data values for a greater number of data attributes (e.g., mortgagee credit score, annual income, etc.) are provided. In some scenarios, embodiment systems may provide a dynamic user interface that can indicate a resource allocation prediction with a percentage confidence value despite unknown annual income data for a mortgage applicant (e.g., 60% chance of approval based on partial mortgage application information). In some scenarios, embodiment systems may also provide a dynamic user interface indicating that if the missing data values associated with particular data attributes are within a proposed range, the percentage confidence value may increase (e.g., if mortgage applicant's annual income is $100,000, then there may be a 95% chance of approval). Other examples of dynamic user interfaces and associated features may be contemplated.

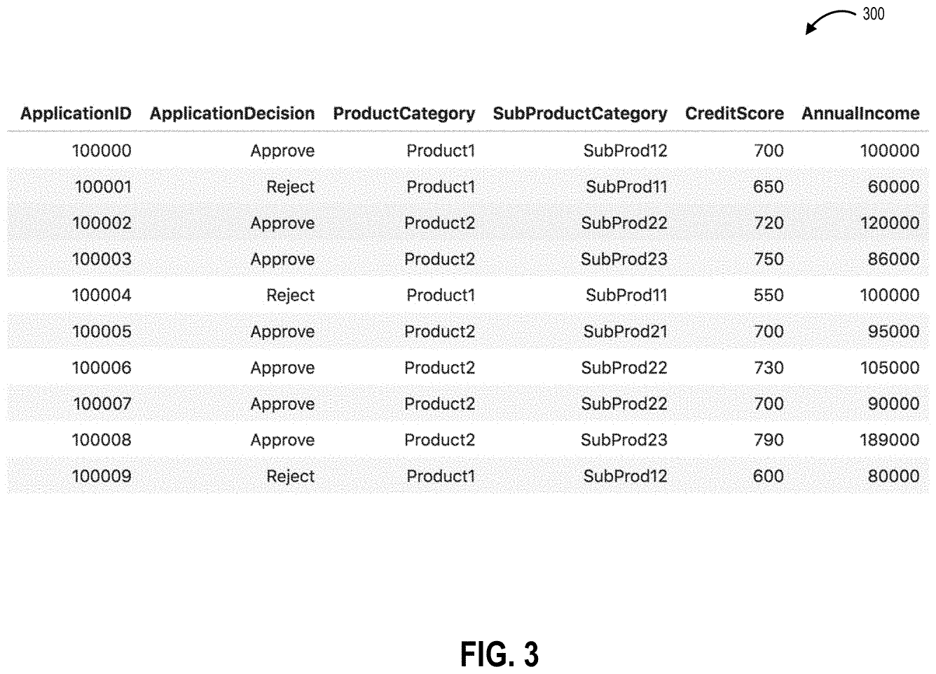

Reference is made to FIG. 3, which illustrates a sample of a prepared dataset 300 generated by the system 100 of FIG. 1, in accordance with an embodiment of the present disclosure. For example, the prepared dataset 300 may be provided following operations of the dataset preparation at stage 206 of the data flow 200 of FIG. 2. The prepared dataset 300 may be stored at the data lake at stage 208 of the data flow 200 of FIG. 2.

As an illustrating example, the sample snippet of the prepared dataset 300 includes a tabular representation of numerous resource allocation requests (e.g., loan applications). Respective rows of the prepared dataset 300 may represent feature attributes of respective resource allocation requests. Feature attributes may be also referred to as data attributes in the present disclosure.

For ease of exposition, the prepared dataset 300 may represent data of numerous loan applications associated with banking customers. In FIG. 3, the prepared dataset 300 includes columns storing data values associated with a resource allocation decision (e.g., loan application approval or rejection), product categories and sub-product categories, credit score of a banking customer associated with a loan application, and annual income of the banking customer associated with the loan application.

In the present example, respective product categories may be inter-related with a sub-product category, such that features or characteristics of a sub-product category may be a derivative of features or characteristics of an associated product category. In some embodiments, the inter-relation among product categories and sub-product categories may be described as a hierarchical relation, and may correspond to a relation akin to a genus and species relation.

In the context of resources allocated by banking institution systems, an example product category may be “secured-asset loan” and example product sub-categories may be “conventional mortgage”, “mortgage with associated home-equity line of credit”, etc. Another example product category may be “lines of credit” and example associated product sub-categories may include “home equity line of credit”, “student line of credit”, “un-secured personal line of credit”, etc. Systems and methods of the present disclosure may include operations for encoding inter-relations or hierarchical relations among feature attributes for generating resource allocation predictions in spite of dataset deficiencies in prior domain knowledge or data value deficiencies in resource allocation queries. In some embodiments, encoded inter-relations or hierarchical relations among feature attributes may be for increasing accuracy when providing explanation/justification for the generated resource allocation predictions.

The prepared dataset 300 illustrated in FIG. 3 is exemplary. The prepared dataset 300 may include a plurality of other columns representing feature attributes, including as examples: number of mortgage products applied for in the past and types of products applied for in the past (e.g., conventional mortgage loan, home equity loans, etc.), total monetary loan value sought by banking customer, past approved loan amount, current balance of prior approved loan amount, type of property against which a security interest may be held, interest rate associated with a prior approved loan, or other feature attributes that may be related or relevant for generating resource allocation prediction outcomes.

In some embodiments, the prepared dataset 300 may include columns representing other feature attributes, including: additional credit bureau data, such as data representing a number of inquiries in the past 6 months or 12 months associated with the respective banking customer, number of account payment delinquencies, or other similar information. In some embodiments, the prepared dataset 300 may include columns representing further feature, such as financial or employment data including aggregate asset values of banking customers, investment holding value of banking customers, net worth of banking customers, debt service ratio values (e.g., gross debt service ratio or total debt service ratio), property appraisal values, banking customer location information, or other data that may be pertinent to evaluating whether a resource allocation (e.g., monetary loan) may be advanced to a banking customer.

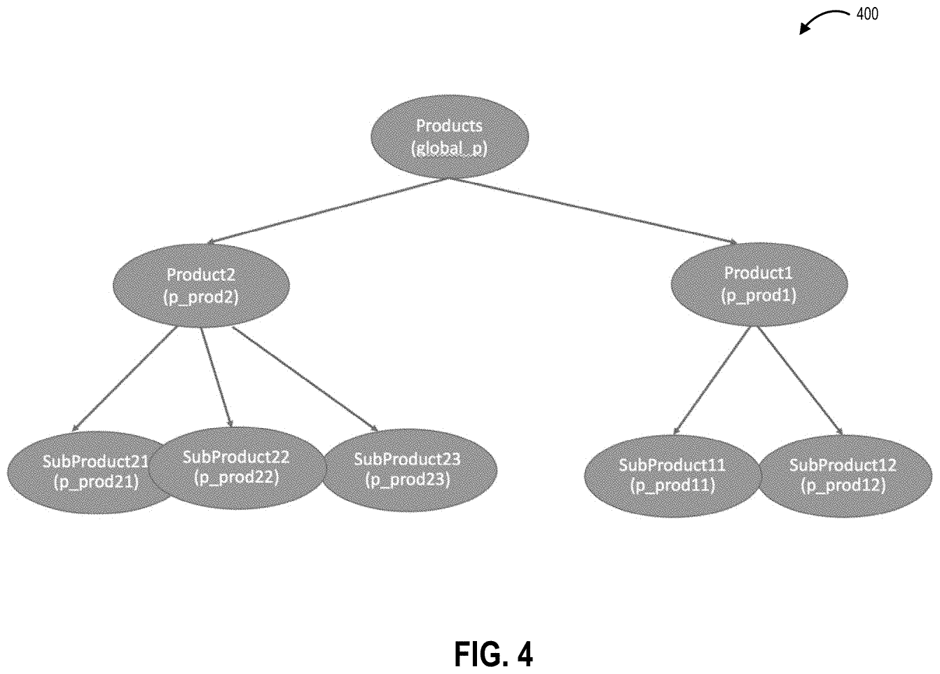

Reference is made to FIG. 4, which illustrates a representation of a data structure 400, in accordance with an embodiment of the present disclosure. In FIG. 4, the data structure 400 may be in the form of a tree data structure. It may be appreciated that other representations of data structures may be contemplated, such as node-link diagrams, graphs, or other representations.

In some embodiments, prepared datasets may be associated with a number of features or dimensions. For example, datasets may include feature attributes associated with product categories, product sub-categories, credit score data, annual income data, or other fields described with reference to FIG. 3. There may be inter-relations or hierarchical relations among data fields. As an example, data fields associated with product categories (e.g., asset-secured loans) may be related to data fields associated with product sub-categories (e.g., mortgage products with home equity lines of credit). In another example, data fields associated with a country location field may be related to data fields associated with state/province location field or with city location field. For ease of exposition, in some examples, inter-relation among feature attributes may be described as a hierarchical relation, such as corresponding to a relation akin to a genus and species relation. In some embodiments, feature attributes may be derivatives of characteristics of other feature attributes. In some embodiments, the system 100 (FIG. 1) may conduct operations to determine relationships among feature attributes, such as whether there may be a correlation between annual income and occupation of a loan applicant, or whether there may be a correlation between two geographical locations. The system 100 may conduct operations by evaluating datasets for determining such correlations, such as whether particular feature attributes may be a broader category of another feature attribute.

The data structure 400 illustrated in FIG. 4 shows an example hierarchical nature of features. For example, there may be two general product types: “Product 1” (e.g., asset-secured loans) and “Product 2” (e.g., credit card accounts). For each product category, there may be associated sub-product categories. For instance, “Product 1” may be associated with the sub-product categories: “SubProduct 11” (e.g., conventional mortgage) and “SubProduct 12” (e.g., mortgage with associated home equity line of credit). “Product 2” may be associated with the sub-product categories: “SubProduct21” (e.g., credit card brand 1), “SubProduct22” (e.g., credit card brand 2), and “SubProduct 23” (e.g., credit card brand 3).

In some embodiments, based on datasets representing a prior knowledge domain, the respective product types may be associated with a probability of “approve” decision. For instance, the prior knowledge domain may be based on datasets of prior credit related applications in prior points in time and from a plurality of banking customers. The inter-relation or hierarchical relation associated with outcome probabilities may provide a basis for a resource allocation prediction model for predicting resource allocation decisions.

As an example of associated probabilities of “approve” decisions based on datasets representing prior domain knowledge, in FIG. 4, given no other information, an inherent probability of approval (e.g., default) may be associated with Products (global_p). Based on datasets representing prior domain knowledge and operations for encoding said datasets, embodiment systems may estimate that a probability of approval associated with “Product1” may be lower than the probability of approval associated with “Product2”. Such estimates of probabilities associated with nodes of the data structure 400 may be defined as a prior probability distribution for the respective nodes.

In an example, based on datasets representing prior domain knowledge and operations for encoding said datasets, embodiment systems may estimate that among the sub-product categories, “SubProduct22” and “SubProduct23” may have the highest probabilities of approval. In the present example, prior probability distributions may be associated with “SubProduct22” and “SubProduct23” to indicate higher probabilities of approval, as compared to other sub-product categories. In the present examples, prior domain knowledge may inform probabilities of approval for particular product categories as compared to other product categories.

To describe embodiments of the present disclosure, another example dataset is provided as follows:

| Application | | Annual | | Credit | Location: | Location: |
|---|---|---|---|---|---|---|
| Number | Decision | Income | Occupation | Score | Province | City |
| 1 | Approve | 100,000 | Computer | 800 | Ontario | Toronto |
| | | | Programmer | | | |
| 2 | Decline | 20,000 | Student | 620 | British | Vancouver |
| | | | | | Columbia | |
| 3 | Approve | 50,000 | Artist | 750 | Quebec | Montreal |

In the above-illustrated dataset, embodiment systems may conduct operations to identify that there may be an inter-relation or hierarchical relation among the location fields (province, city, etc.). In some other embodiments, there may be an inter-relation or hierarchical relation among other fields, such as industry (not illustrated in the above sample dataset) and occupation. As will be described, embodiment systems may conduct operations to encode datasets to provide probability distributions to provide resource allocation predictions.

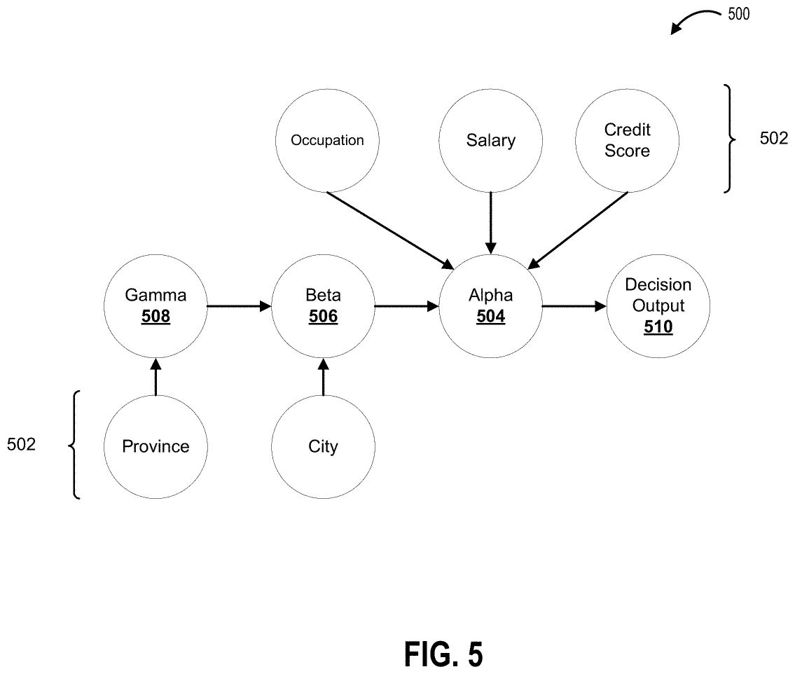

Reference is made to FIG. 5, which illustrates a directed graph structure 500 associated with the above-illustrated dataset, in accordance with an embodiment of the present disclosure. The directed graph structure 500 may include one or more nodes that may represent observed or computed data values 502, such as nodes associated with Location-Country, Location-City, Credit Score, Salary, or Occupation.

The directed graph structure 500 may also include one or more computed nodes associated with conditional distribution representations. For instance, a computed node labelled “Alpha” 504 may represent a conditional distribution based on: (i) observed data from prior domain knowledge; or (ii) conditional distributions representing other computed nodes of the directed graph structure (e.g., computed node with name “Beta” 506″ or with name “Gamma” 508). The computed node with name “Beta” 506 may represent a conditional distribution based on: (i) observed data from prior domain knowledge (e.g., observed value for City); or (ii) conditional distribution representing the node named “Gamma” 508″. In addition, the computed node with name “Gamma” 508 may represent a conditional distribution based on observed data of prior domain knowledge (e.g., observed value for province).

As an illustrating example with reference to the directed graph structure 500, a target decision output 510 may be associated with a conditional distribution representation defined by:

T˜Bernoulli distribution(p=Alpha).

An example conditional distribution representation associated with the node “Alpha” 504 may be defined by:

Alpha˜Dirichlet distribution(p=x*Salary+y*Credit Score+z*Occupation+w*Beta)

An example conditional distribution representation associated with the node “Beta” 506 may be defined as:

Beta˜Normal distribution(mean=City*w1+Gamma*w2, Variance=constant)

Furthermore, in the present example, embodiment systems may conduct operations to generate a probability distribution based on location province data in datasets associated with prior domain knowledge.

In some embodiments, the system 100 may conduct operations to determine a distribution description that may be representative of the historical datasets. For instance, the system 100 may also evaluate whether other types of distribution curves (aside from a Gaussian distribution) may be suitable for the node “Beta” 506.

In the above described examples of conditional distribution representations, coefficients, such as x, y, z, and w associated with the “Alpha” distribution or w1 and w2 associated with the “Beta” distribution, may be determined or tuned via an iterative process during model training operations. The example conditional distribution representations at the Alpha 504, Beta 506, or Gamma 508 nodes may be any other distribution representations, and may be determined during model generation operation processes. For example, the conditional distribution representation at the Beta 506 node could be any other type of distribution, such as a Bernoulli distribution, etc.

Based on examples provided herein, embodiment systems and methods of the present disclosure may be directed to generating conditional distribution representations (e.g., representations associated with the directed graph structure 500 of FIG. 5) to encode inter-relations or hierarchical relations among features (e.g., location-province, location-city, credit score, salary, occupation, etc.) of datasets representing prior domain knowledge. Prior domain knowledge may include datasets representing, for example, data records associated with resource allocation decisions and associated decision making data.

Encoding of prior domain knowledge associated with datasets may be desirable for representing prior domain knowledge as conditional distribution functions that may be used to generate resource prediction outcomes in spite of unrepresentative number of prior data record samples associated with a particular “Location: City”. For example, the number of prior data record samples for mortgage applications in North Bay, Ontario, may be small compared to the number of prior data record samples for mortgage applications in Toronto, Ontario. In view of unrepresentative number of prior data record samples associated with a particular “Location: City”, embodiment systems may conduct operations to generate resource allocation predictions based on conditional distribution representations of “Location: Province” (as an example), as prior domain knowledge associated with a related province or region may be useful for providing an alternate resource allocation prediction. That is, the conditional distribution representation associated with the node named “Beta” 506 may include a concatenation or combination of: (a) a distribution representation associated with “Location: City” data; and (b) a conditional distribution representation associated with the node named “Gamma” 508.

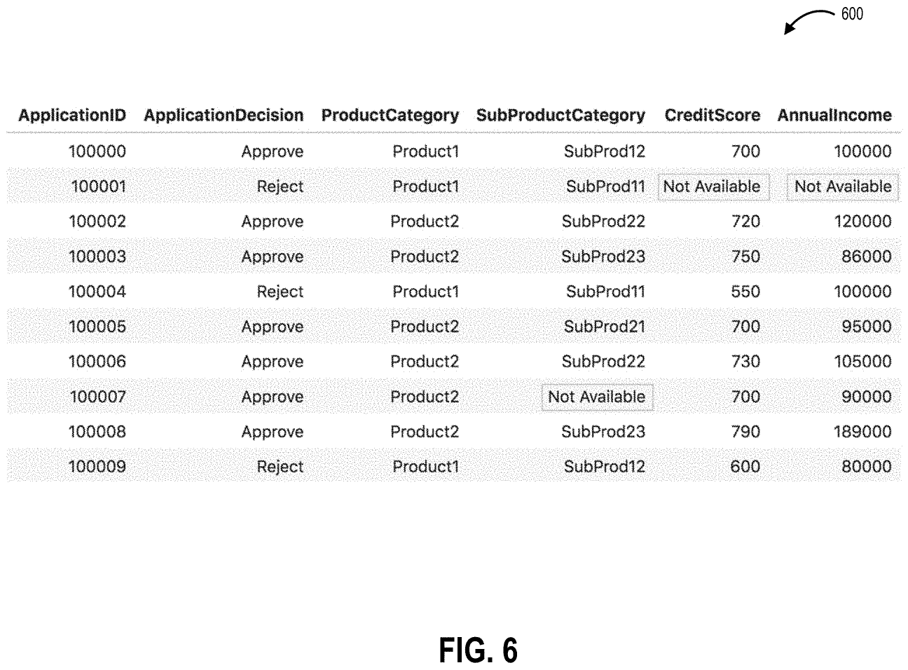

When implemented by embodiment systems, example conditional distributions may provide representations of prior domain knowledge and inter-relations among features in datasets associated with prior domain knowledge. In some embodiments, systems and methods may: (1) generate resource allocation predictions with increased accuracy in spite of unrepresentative datasets associated prior domain knowledge for particular features; or (2) generate imputed data values for data records based on conditional distributions of encoded prior domain knowledge, such that said data records having missing data values may be imputed with data value(s) based on probability distribution representations. Examples will be described with reference to FIG. 6.

Reference is made to FIG. 6, which illustrates a sample of a prepared dataset 600 generated by the system 100 of FIG. 1, in accordance with an embodiment of the present disclosure. The prepared dataset 600 may be provided following dataset preparation operations at stage 206 of the data flow 200 of FIG. 2. The prepared dataset 600 may represent data attributes of respective resource allocation requests. The prepared dataset 600 may be similar to the prepared dataset 300 of FIG. 3; however, the sample prepared dataset 600 may have feature attributes having missing or otherwise unavailable data values.

When encountering data fields having null or missing values, some example machine learning-based systems may conduct operations to eradicate null or missing data values. For example, machine learning-based systems may remove data records identified as having null or missing data values, or may replace missing data values with a most frequently occurring alternative value for the purpose of model training. Removing data records when null or missing data values are identified may effectively reduce a sample size of prior domain knowledge. Imputing missing data values with most frequently occurring alternative values may impute incorrect data or may cause skewing of a dataset representing prior domain knowledge. It may be beneficial to provide systems and methods directed to missing data imputation based on probability distribution representations, where the probability distribution representations may be based on encoded inter-relations or hierarchical relations among feature attributes.

The example prepared dataset 600 of FIG. 6 includes missing data values as follows:
For Application ID 100001, missing “Credit Score” data value and missing “Annual Income” data value;
For Application ID 100007, missing “Sub Product Category” data value.

Embodiment systems and methods of the present disclosure may conduct operations directed to predicting missing data values based on prior probability distributions associated with the respective feature attributes. For example, to impute the missing Credit Score data value for Application ID 100001, embodiment systems may conduct operations to infer that the missing Credit Score value may be a relatively small number. The data value inference may be based on a Gaussian distribution with a mean value of 620, given that Application ID 100001 included an Application Decision value=Reject and given prior domain knowledge that Product 1 and SubProduct11 have a lower likelihood of being approved.

To impute the missing Annual Income data value for Application ID 100001, embodiment systems may conduct operations to infer that the missing Annual Income data value is likely relatively small, and may be based on a Gaussian distribution with a mean value of $50,000.

In another example, to impute the missing Sub Product Category data value for Application ID 100007, embodiment systems may conduct operations to infer that “SubProduct11”, “SubProduct22”, or “SubProduct23” are determined to be popular products among banking customers. However, given that the “SubProduct11” may be associated with a low probability of being approved (based on prior domain knowledge), embodiment systems may conduct operations to determine that the missing data value may be one of “SubProduct22” or “SubProduct23” based on prior probability distribution representations of prediction models of embodiment systems described in the present disclosure.

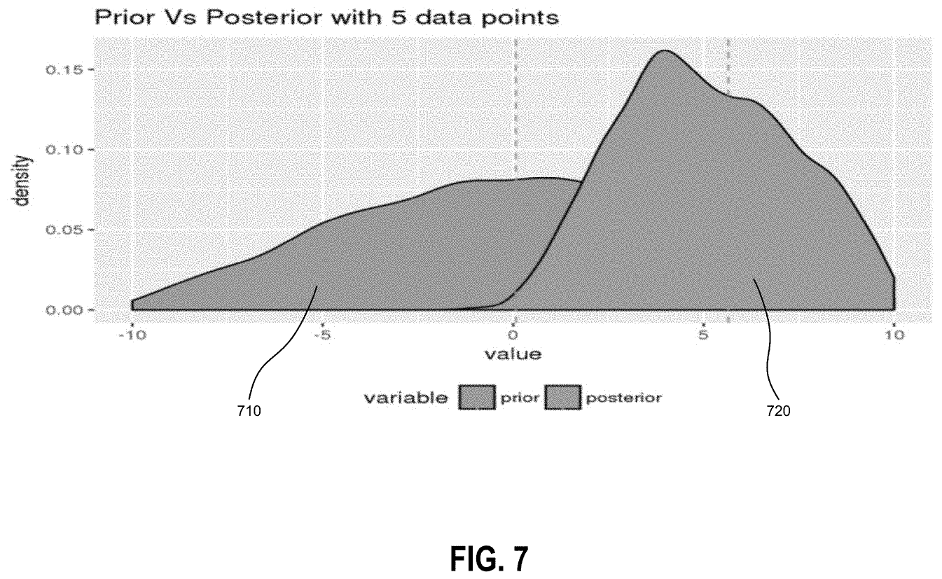

Reference is made to FIGS. 7, 8, 9, and 10, which illustrate conditional probability distribution plots comparing: (i) conditional distribution representations 710 based on datasets of prior domain knowledge; and (ii) conditional distribution representations 720 based on historical resource allocation datasets (e.g., data warehouse 202 of FIG. 2) that may be supplemented with additional data records for a particular data feature over time. In FIGS. 7, 8, 9, and 10, the x-axis may represent a spectrum or range of possible prediction decision outputs and the y-axis may represent a density of the probability distribution for particular prediction decision output values. In some scenarios, the density represented by the y-axis may illustrate a confidence measure associated with a particular prediction decision output value.

FIG. 7 illustrates a comparison of a “prior” conditional distribution representation based on an initial prior domain knowledge and a “posterior” conditional distribution representation based on 5 additional data records. In FIG. 7, the y-axis scale ranges from approximately 0.00 to 0.15.

In the present example, embodiment systems may conduct operations to refine coefficients of a conditional distribution representation as additional data records are received for training operations. As an illustration, referring to example conditional distribution representations described with reference to FIG. 5, embodiment systems may conduct operations to refine coefficients such as “w1” or “w2” or a constant variance value for a normal distribution to provide the “posterior” conditional distribution representation 720.

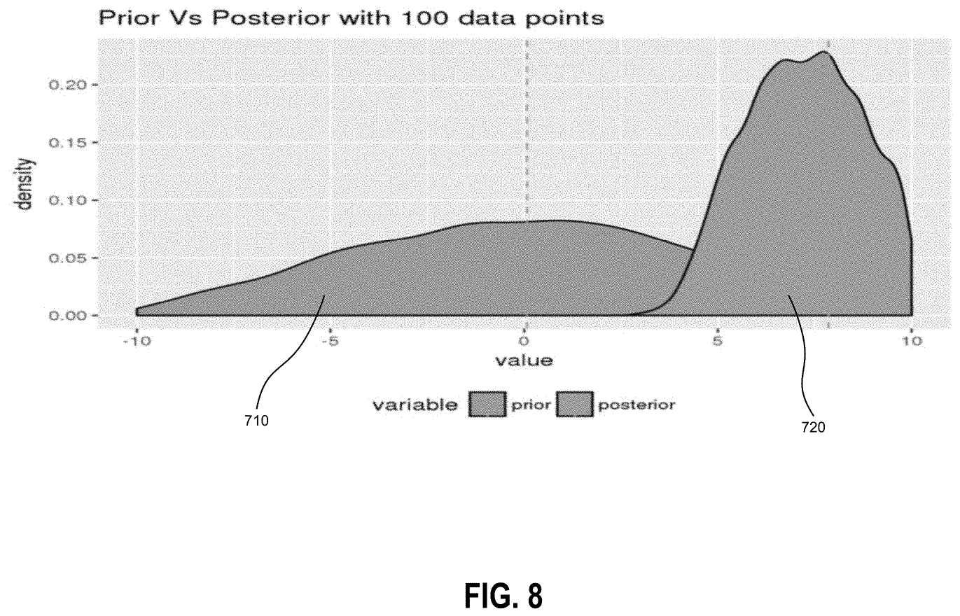

FIG. 8 illustrates a comparison of a “prior” conditional distribution representation 710 and a “posterior” conditional distribution representation 720 based on 100 additional data records received by embodiment systems for training operations. In FIG. 8, the y-axis scale ranges from approximately 0.00 to 0.20.

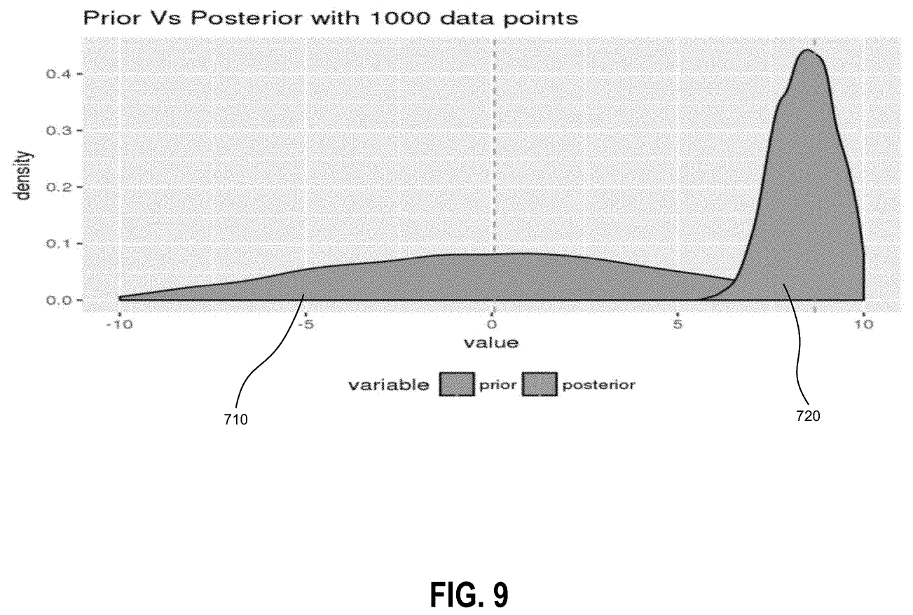

FIG. 9 illustrates a comparison of a “prior” conditional distribution representation 710 and a “posterior” conditional distribution representation 720 based on 1,000 additional data records received by embodiment systems for training operations. In FIG. 9, the y-axis scale ranges from approximately 0.00 to 0.4

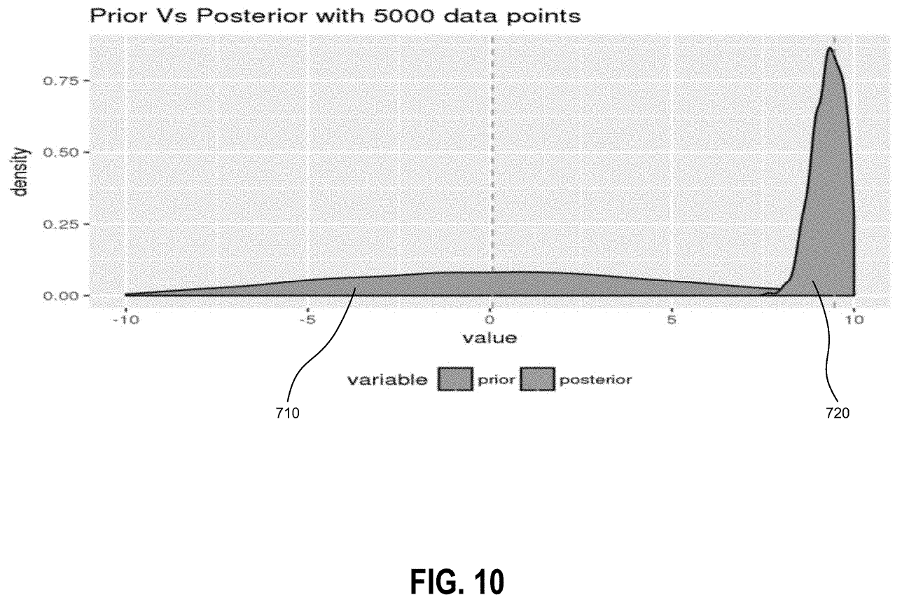

FIG. 10 illustrates a comparison of a “prior” conditional distribution representation 710 and a “posterior” conditional distribution representation 720 based on 5,000 additional data records received by embodiment systems for training operations. In FIG. 10, the y-axis scale ranges from approximately 0.00 to 0.75.

Examples plots in FIGS. 7, 8, 9, and 10 illustrate a shift in a concentrated reliance on a conditional distribution representation based on “prior” domain knowledge to a “posterior” conditional distribution representation. When additional data records are provided for training operations, embodiment systems may generate conditional distribution representations having confidence indicators associated with a prediction output value. For instance, in FIG. 10, a confidence that a predicted output value=8.5 (shown in FIG. 10) may be greater than a confidence that a predicted output value=8.5 (shown in FIG. 9).

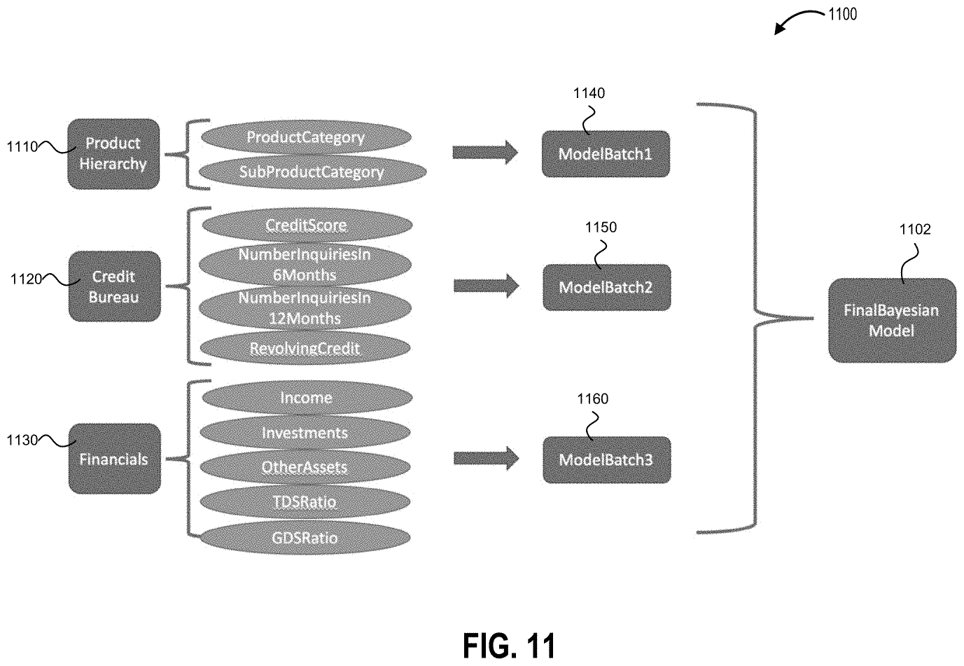

Reference is made to FIG. 11, which illustrates an architecture diagram of a resource allocation prediction model 1100, in accordance with an embodiment of the present disclosure. The resource allocation prediction model 1100 may include a base model component 1102 and may include one or a plurality of sub-model components. The base model component 1102 may be a model providing a resource allocation prediction output based on the spectrum of data record data fields.

As an illustrating example, a plurality of sub-model components may include a sub-component associated with a product hierarchy 1110, a sub-component associated with credit bureau-related data 1120, or a sub-component associated with financials-related data 1130.

In an example, a product hierarchy 1110 may be conceptually represented by a data structure, such as the example tree representation illustrated in FIG. 4. In some embodiments, systems and methods may be directed to generate a sub-component model 1140 for encoding or describing inter-relations or hierarchical relations among the Product and Sub-Product categories based on determined inter-relations among data values associated with Product and Sub-Product category data fields.

Similarly, systems and methods disclosed herein may be directed to generate a sub-component model 1150 for encoding inter-relations among data fields pertinent to Credit Bureau data 1120, including credit score, “number of inquiries in past 6 months”, “number of inquiries in past 12 months”, or “quantity of revolving credit”.

Systems and methods may be directed to generate a sub-component model 1160 for encoding inter-relations among data fields pertinent to Financial related data 1130, including annual income, investment value, other asset value, or debt-to-service ratio values.

By generating sub-component models, embodiment systems and methods may generate conditional distribution representations that may be illustrated with directed graph structures (e.g., see FIG. 5 as an example), and systems may conduct operations to predict resource allocation outputs based on the inter-related conditional distribution representations of the respective sub-component models.

By generating sub-component models, embodiment systems may be configured to generate a plurality of conditional distribution representations for a group of inter-related features or data fields. Based on generated models, systems may be configured to impute missing or unavailable data values based on relevant probability distribution representations of prior domain knowledge data sets. By generating sub-component models, embodiment systems may be configured to train the base model component 902 on larger datasets with increased efficiency, at least, because the sub-component models may be independently trained prior to operations for concatenating conditional probability distribution representations of the plurality of sub-component models to provide the base model component 902.

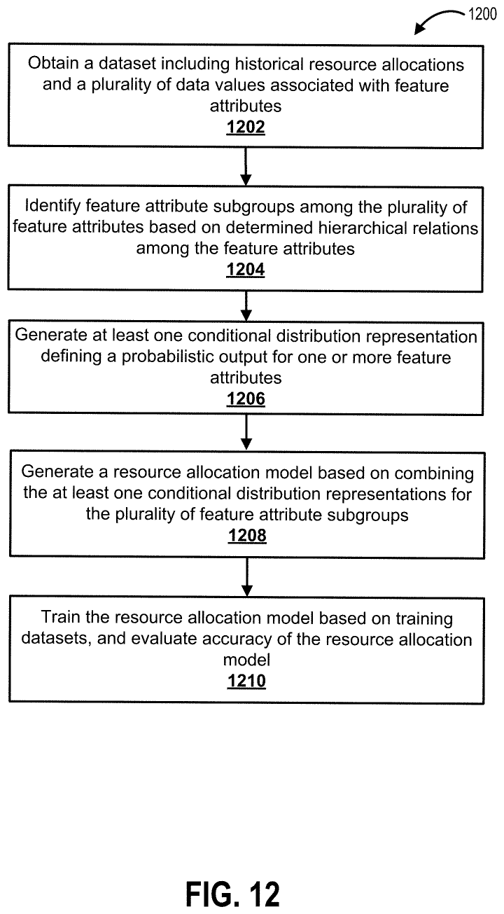

Reference is made to FIG. 12, which illustrates a flowchart of a method 1200 of generating and training a resource allocation model, in accordance with embodiments of the present disclosure. The method 1200 may be conducted by the processor 102 of the system 100 (FIG. 1). Processor-executable instructions may be stored in the memory 106 and may be associated with the resource allocation application 112 or other processor-executable applications not illustrated in FIG. 1. The method 1200 may include operations, such as data retrievals, data manipulations, data storage, or other operations, and may include computer-executable operations.

At operation 1202, the processor may obtain a dataset including historical resource allocations and a plurality of data values associated with feature attributes. In examples where the resource allocation application 112 may be configured to adjudicate mortgage loan applications, the dataset may be prior domain knowledge based on historical mortgage loan application adjudication results (e.g., approve or deny) based on a plurality of data values associated with feature attributes. Data values associated with feature attributes may include feature attributes that are relevant to adjudicating the mortgage loan application (e.g., applicant's credit score, annual income, etc.). The prior domain knowledge may be based on multi-featured data attributes and may represent numerous dimensions on which the mortgage loan application may be adjudicated.

At operation 1204, the processor may identify feature attribute subgroups among the plurality of feature attributes of the obtained dataset. For example, the processor may identify feature attributes that may inter-relate with other feature attributes based on a hierarchical relation. In some embodiments, an inter-relation among feature attributes may be described as a relation akin to a genus and species relation. For instance, feature attribute for Location-Country may be inter-related with feature attributes for Location-State/Province or Location-City or Location-Region. Characteristics of data values for a particular country (e.g., Canada or United States) may be related to characteristics of data values for a particular state/province or a particular city. As an simplified illustrating example, a conditional distribution representation associated with the Province of Ontario may be broadly representative of a conditional distribution representation associated with the City of Toronto; however, the conditional distribution representation associated with the City of Toronto may be associated with characteristics specific to the City of Toronto, thereby encoding more granular characterization of features. In scenarios where data samples for the City of Toronto may be unrepresentative (e.g., low number of sample data records) or where data value for a feature attribute “Location-City” may be unavailable, systems described herein may conduct operations for allocation predictions based on other feature attributes inter-related by a hierarchical relation.

At operation 1206, the processor may generate at least one conditional distribution representation defining a probabilistic output for one or more feature attributes. For ease of exposition, referring again to the directed graph structure of FIG. 5, the processor may generate conditional distribution representations associated with nodes named Alpha 504, Beta 506, and Gamma 508. The conditional distribution representations may be generated based on data values associated with respective feature attributes from a historical resource allocation dataset (e.g., a prior domain knowledge).

The respective conditional distribution representations may be stored as dataset representations of distributions such as Bernoulli distributions, Dirichlet distributions, Gaussian distributions, or other types of distributions. The distributions may be defined with reference to parameters of the respective distributions. For instance, a Gaussian distribution may be defined based on a mean and a standard variation based on data values of an analyzed dataset.

In some embodiments, the processor may conduct operations to iteratively define conditional distribution representations for defining the resource allocation model. For example, as further historical resource allocation datasets may be analyzed, the processor may determine that the dataset may be better described based on a Dirichlet distribution, rather than a Gaussian distribution or other distribution.

In some embodiments, the processor may iteratively refine parameters for defining the respective conditional distribution representations. For example, referring again to the described examples from FIG. 5, the processor may iteratively determine or refine the x, y, z, or w coefficients/parameters of the Dirichlet distribution at the node labelled “Alpha”.

In some embodiments, the processor may generate sub-component models associated with feature attributes grouped as feature sub-groups. For instance, in FIG. 11, a resource allocation sub-component model (e.g., ModelBatch1) may be generated based on the respective conditional distribution representations associated with product hierarch feature attributes.

At operation 1208, the processor may generate a resource allocation model based on combining the at least one conditional distribution representations. In some embodiments, the processor may conduct operations associated with distribution concatenation to generate an overall resource allocation model 1102 (FIG. 11). The resource allocation model may provide resource allocation predictions based on a set of feature attributes from an historical dataset.

At operation 1210, the processor may train the resource allocation model based on training datasets, and evaluate accuracy of the resource allocation model. In some embodiments, during training of the resource allocation model, the processor may determine accuracy of the resource allocation model based on training datasets and evaluation datasets. In scenarios when the processor determines that the resource allocation model attains a defined accuracy threshold for a desired number of training cycles, the processor may update the resource allocation model in a system data flow. For example, referring again to FIG. 2, when the processor determines that the resource allocation model attains a defined accuracy threshold, the processor may associate the trained (or updated) resource allocation model with the resource allocation application interface 214 (FIG. 2).

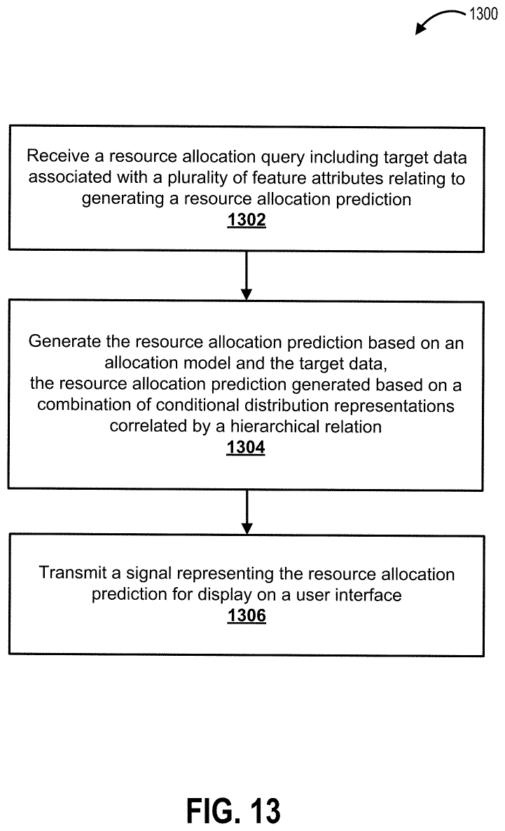

Reference is made to FIG. 13, which illustrates a flowchart of a method 1300 for machine learning architecture for resource allocation, in accordance with embodiments of the present disclosure. The method 1300 may be conducted by the processor 102 of the system 100 (FIG. 1). Processor-executable instructions may be stored in the memory 106 and may be associated with the resource allocation application 112 or other processor-executable applications no illustrated in FIG. 1. The method 1300 may include operations, such as data retrievals, data manipulations, data storage, or other operations, and may include computer-executable operations.

For ease of exposition, operations of method 1300 may be described with reference to an example of the system 100 configured to adjudicate a mortgage loan application for providing a resource allocation prediction. The resource allocation application 112 may obtain a prior trained resource allocation model. An example of the resource application 112 conducting operations in concert with a resource allocation model may be shown, for example, at stage 214 of FIG. 2.

At operation 1302, the processor receives a resource allocation query including target data associated with a plurality of feature attributes relating to generating a resource allocation prediction. For example, the resource allocation query may include a data record including data values for a plurality of feature attributes, such as a mortgage loan applicant's credit score, annual income sources, data regarding history of payment delinquencies, occupation, loan product sought, real estate property type or location, or other feature attributes relevant for adjudicating whether to approve or decline a mortgage loan application or what quantity of resources (e.g., currency) to provide as a mortgage loan.

At operation 1304, the processor may generate the resource prediction based on an allocation model and the target data. In some embodiments, the allocation model may be defined by at least one conditional distribution representation for providing an interim prediction corresponding to one or more feature attributes.

To illustrate with reference to the directed graph structure 500 of FIG. 5, a prior trained allocation model may define conditional distribution representations conceptually associated with one or more nodes of the directed graph structure 500. For instance, the prior trained allocation model may have defined a conditional distribution representation associated with a Location-City as a normal distribution (e.g., at node 506 “Beta”). The conditional distribution representation may indicate that a probability of approval or denial of a mortgage loan application when the feature attribute of Location-City=Toronto may be distributed about a mean value and a standard deviation value. In the present example, the mean value may be a weighted calculation based on the city and another conditional probability distribution associated with the feature attribute: Location-Province. In some examples, interim predictions corresponding to one or more features may be provided. Such interim predictions may be represented as conditional distributions, which may be combined with other conditional distributions (e.g., distribution represented by Beta 506 combined with Alpha 504) to provide a decision prediction.

Thus, in some embodiments, the resource allocation prediction may be generated based on a combination of conditional distribution representations respectively correlated with other conditional distribution representations by a hierarchical relation.

In some embodiments, the hierarchical relations may correspond to a genus-species relation among a plurality of feature attributes associated with at least one conditional distribution representations. For example, in situations where the number of dataset samples associated with prior domain knowledge (e.g., records of past mortgage loan application decision results) may be relatively low, the processor may utilize prior domain knowledge of a broader but relevant conditional distribution data for providing an allocation prediction. For example, when the number of dataset samples associated with Sudbury (Ontario) may be limited, the processor may utilize prior domain knowledge of the Northern Ontario region, which may still be useful data.

In some embodiments, the resource allocation prediction may be based on a Bernoulli distribution. The Bernoulli distribution may be based on a combination of conditional distribution representations, as described in the example illustrated in FIG. 5.

In some embodiments, at least one conditional distribution representation may include a Dirichlet distribution defined by at least one other conditional distribution representation and historical data values corresponding to any other feature attributes.

In some embodiments, at least one conditional distribution representation may include a Gaussian distribution defined based on a mean of weighted data values associated with a feature attribute of the historical resource allocation dataset.

In the above-described examples, by combining one or more conditional distributions associated with feature attributes, the processor may generate a resource allocation prediction that may factor the respective probability distributions of mortgage loan acceptance/denial for relevant feature attributes.

Using the directed graph structure 500 illustrated in FIG. 5 as an example, the processor at operation 1304 may provide data values of feature attributes (from the resource allocation query of operation 1302) to the respective observed nodes 502 (e.g., feature attributes=occupation, annual income, credit score, location province or city), and the processor may determine an allocation prediction based on the hierarchical related conditional probability distributions conceptually depicted in the directed graph structure 500.

At operation 1306, the processor may transmit a signal representing the resource allocation prediction for display on a user interface. For example, the signal representing an acceptance of the mortgage loan application for a requested loan amount may be transmitted to a client device 130 (FIG. 1) for an adjudicator user to view on a graphical user interface.

In some embodiments, the signal representing the resource allocation prediction may include an indication of quantity of resources that the mortgage applicant may be approved for. For example, the resource allocation prediction may indicate that a $400,000 mortgage loan amount will likely be approved, or that the $500,000 mortgage loan amount will likely be declined but that a $400,000 mortgage loan amount may be approved with 92% confidence.

In some embodiments, the signal representing the resource allocation prediction may provide one or more graphical user interfaces to aid interpretation of the resource allocation prediction. For example, the graphical user interfaces may illustrate a conditional distribution curve indicating a region under the distribution curve associated with the applicant's target data. In some embodiments, the graphical user interfaces may include a multi-dimensional graphical representation associated with two or more feature attributes. For example, when considering the feature attributes of annual income and credit score, a two-dimensional Cartesian graph may be illustrated showing where on the two-dimensional graph the applicant's target data is located. In some embodiments, the multi-dimensional graphical representation may be akin to a “heat-map”, where the applicant's target data may be overlaid with gradations of the “heat-map” to illustrate probability of the applicant's mortgage loan application being accepted based on the identified two feature attributes (e.g., credit score and income as examples).

In some embodiments, the processor at operation 1302 may determine that the resource allocation query may include at least one unavailable data value associated with a given feature attribute. The processor may, prior to generating the resource allocation prediction, generate an imputed data value in place of the unavailable data value based on a conditional distribution representation associated with the given feature attribute.

For example, if the resource allocation query does not include a data value associated with the applicant's annual income, the processor may generate an imputed value based at least in part on the applicant's occupation, credit score, location, or other feature attributes. The imputed value may be based on prior determined conditional distributions generated by the machine learning architecture examples described in the present disclosure. For example, the prior determined conditional distributions may be combined and may represent a probabilistic data value for the applicant's annual income, such that the machine learning architecture may make an educated “guess” of the missing data value. The prior determined conditional distributions may be based on historical data values of the given feature attribute (e.g., annual income), such as the prior domain knowledge.

In some embodiments, the processor may generate an imputed confidence value associated with a resource allocation prediction that is based on an imputed data value. The confidence value may provide a mortgage adjudicator user an indication of how reliable the allocation prediction may be, as the allocation prediction may be based on an imputed data value. To illustrate, in the above example, the annual income may be an imputed value based on other feature attributes of the mortgage loan applicant. In some scenarios, the imputed annual income may be associated with a high confidence value when a combination of distribution representations of other feature attributes provide an indication of high probability density.

In some embodiments, the processor may receive a signal representing an explanation query associated with at least one queried feature attribute. The processor may generate a signal representing an explanation representation based on a conditional distribution representation corresponding to the at least one queried feature. The explanation representation may be provided as a graphical user interface element for indicating a confidence measure corresponding to the resource allocation prediction. For example, the explanation representation may be in the form of a Gaussian distribution curve for illustrating the mortgage loan applicant's current income under the distribution curve, and may provide a visual indication whether the income level may be a contributing feature to a resource allocation prediction result.

Embodiments of graphical user interfaces illustrating resource prediction outcomes and graphical user interfaces for interpreting resource predictions may be shown in the below described drawings.

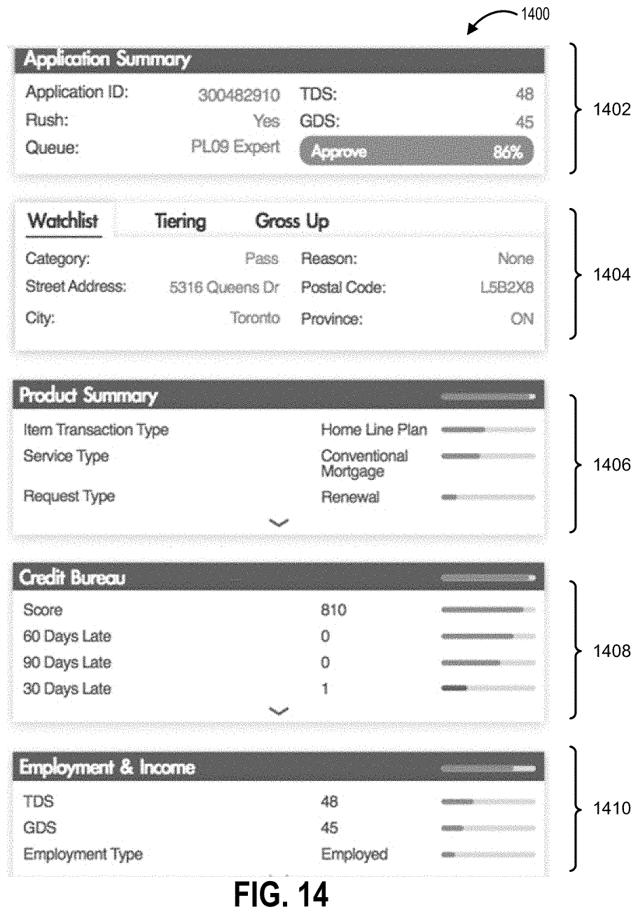

Reference is made to FIG. 14, which illustrates a portion of a graphical user interface (GUI) 1400 providing resource allocation prediction and associated data output, in accordance with an embodiment of the present disclosure. The GUI includes an application summary portion 1402 for providing summary information relating to a mortgage loan application result. For example, the illustrated summary portion illustrates approval of a mortgage loan application with 86% confidence level. The summary portion 1402 may include summary information relating to mortgage debt-service ratios and application identification numbers.

In some embodiments, the GUI 1400 may include location information portion 1404, which may indicate a target real estate property address, postal code, province, etc. In some embodiments, the GUI 1400 may include a mortgage product portion 1406 for indicating a likelihood that particular products may be approved as a mortgage loan structure. Likelihood indications may be provided via bar-shaped graphical elements indicating a value between a range of extreme values.

In some embodiments, the GUI 1400 may include a credit bureau portion 1408, which may indicate the extent that particular credit bureau feature attributes contributed to the overall resource allocation prediction. In the illustrated example, the graphical interface elements indicate that a 810 credit score weighted heavily in favour of a resource allocation approval, and that an absence of “60 day” and “30 day” late payments on existing credit accounts weighed in favour of a resource allocation approval. The credit bureau portion 1408 may also indicate via graphical interface elements that particular feature attributes weighted “against” a resource allocation approval. In the illustrated example, a detected instance of “30 days late” payment to a credit account weight against the resource allocation prediction. The bar-shaped elements may be overlaid with colours. Green interface elements may indicate that the feature attribute weighted in favour of and red interface elements may indicate that the feature attribute weighted against a resource allocation prediction result.

In some embodiments, the GUI 1400 may include an “Employment & Income” portion 1410 providing indications of the extent that debt-service ratio data or employment status information contributed to an overall resource allocation prediction.

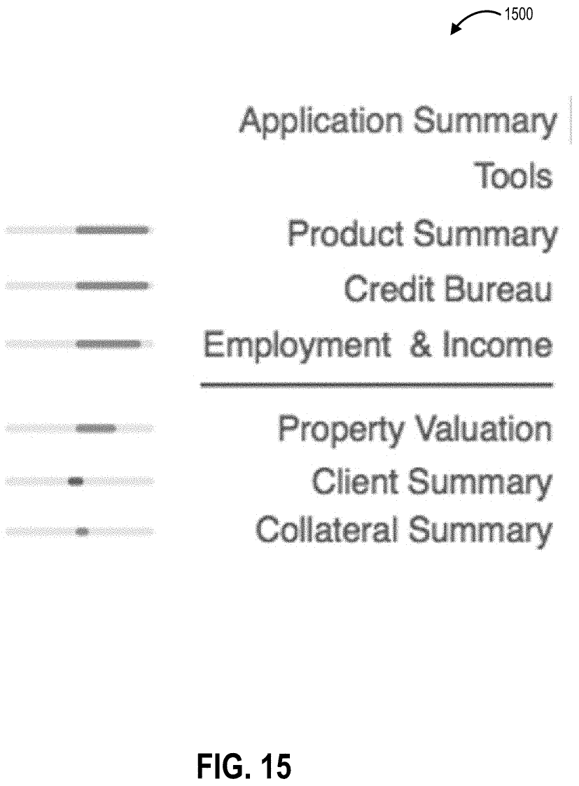

Reference is made to FIG. 15, which illustrates a portion of a graphical user interface (GUI) 1500 providing resource allocation predictions, in accordance with an embodiment of the present disclosure. The GUI 1500 may provide an indication of the extent that respective feature attributes contributed to the resource allocation prediction. For example, in FIG. 15, the bar-shaped elements indicate that feature attribute data associated with “Product Summary”, “Credit Bureau”, and the “Employment & Income” portions of a mortgage loan application weighed in favour of a resource allocation prediction. The bar-shaped elements may be color coded with colours to indicate “in favour of” or “detrimental to” an approval prediction.

The example GUI 1500 also indicates that other feature attribute data associated with “Property Valuation” and “Collateral Summary” contributed to a lesser extent to the overall resource allocation prediction. In the illustrated GUI 1500, feature attribute data associated with “Client Summary” may have weighed against the resource allocation prediction result. When feature attribute data may weigh against a resource allocation prediction result, the bar-shared user interface elements may be colour coded in red, or any other color to distinguish from feature attribute data weighing “in favour of” the prediction.

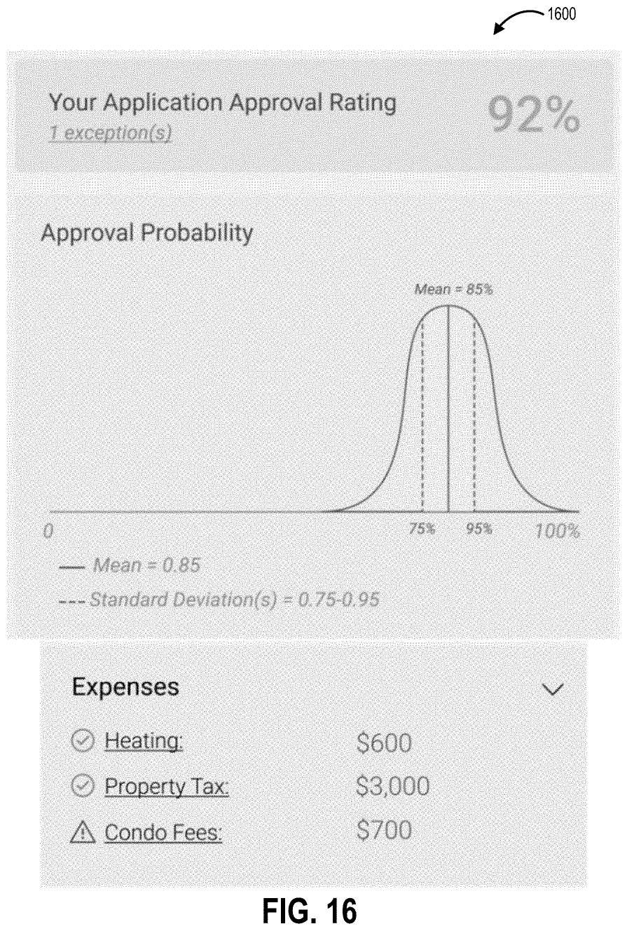

Reference is made to FIG. 16, which illustrates a portion of a graphical user interface (GUI) 1600 providing interface elements associated with interpretability of resource prediction results, in accordance with an embodiment of the present disclosure. In FIG. 16, the interface elements may include distribution representations in graphical form, such as a graphical illustration of a Gaussian distribution showing regions associated with feature attributes that may be associated with a mortgage loan application approval rating. The illustrated distribution representations may be related to conditional distribution representations described in the present disclosure, such as with reference to FIG. 5.

In some embodiments, the GUI 1600 may provide a visualization associated with a confidence level (e.g., approval probability) for the resource allocation prediction. The GUI 1600 may also include a visual indicator of how the present resource allocation query (e.g., mortgage loan application) compares relative to other resource allocation queries having similar data values associated with feature attributes. For example, FIG. 16 illustrates an approval probability of a population.

FIG. 16 includes summary information, such as expected real estate ownership expenses. The GUI 1600 may include hyperlinks and graphical icons (e.g., checkmarks or caution icons), and the hyperlinks may be selectable for providing granular data associated with the graphical icons. For example, the “caution icon” beside “Condo Fees” may indicate that there may be a mismatch between condo fees estimated by the system and condo fee information submitted by a banking customer.

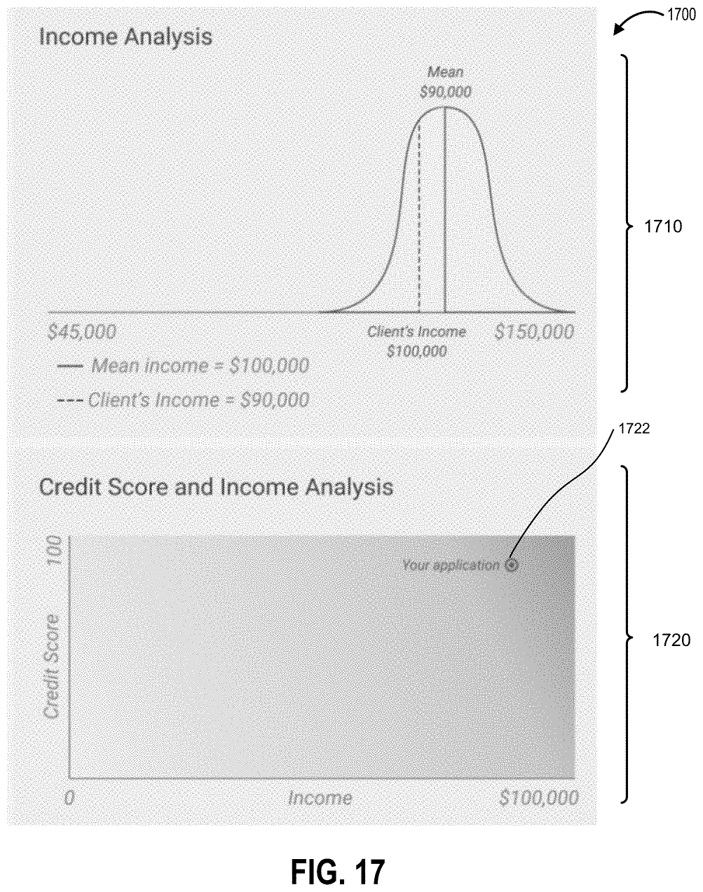

Reference is made to FIG. 17, which illustrates portions of a graphical user interface (GUI) 1700 providing interface elements associated with interpretability of resource prediction results, in accordance with an embodiment of the present disclosure.

In some embodiments, the GUI 1700 may include an income analysis portion 1710 configured to illustrate a mortgage loan applicant's income relative to a distribution of historical income data for mortgage loan applications similar to the current mortgage loan applicant. In some situations, graphically illustrating target data associated with a resource allocation query (e.g., data from a mortgage loan application) relative to historical datasets may provide a mortgage loan adjudicator with comparative metrics for interpreting a resource allocation prediction.

Thus, FIG. 17 may provide a visual user interface providing a comparative analysis of a banking customer's annual income relative to other banking customers. In FIG. 17, the banking client's annual income may be below an average (mean) annual income of other banking customers.

In some embodiments, the GUI 1700 may include a two-dimensional feature attribute graphical analysis 1720. As an example, the GUI 1700 may provide a two-dimensional graph illustrating data ranges for income attributes to credit score attributes. The GUI 1700 may include colour coded “heat-map” type features to illustrate a confidence level of a mortgage loan application being approved on the basis of two particular feature attributes, such as credit score and income. In the illustrated example, the present mortgage loan application may be represented by a graphical element 1722 and may be positioned proximal a region of the “heat-map” having darker shading, thereby indicating a relatively higher confidence level that the mortgage loan application will be approved.

In FIG. 17, the two-dimensional graph may provide a visualization based on two feature attributes: credit score (e.g., an indicator of a banking customer's credit worthiness) and annual income. In the example two-dimensional graph, a graphical element 1722 positioned in a portion of the two-dimensional graph having darker colour or shading may indicate a more favourable outcome for the resource allocation query (e.g., higher likelihood of approval).

In the illustrated example graphical user interfaces, the system may provide interpretive tools for providing “what if” information. For example, a mortgage loan adjudicator may deduce that if a banking customer's income or credit score were to increase, the likelihood of being approved for a mortgage loan would also increase. Embodiments of graphical user interface elements described herein may also be applicable to other feature attributes.

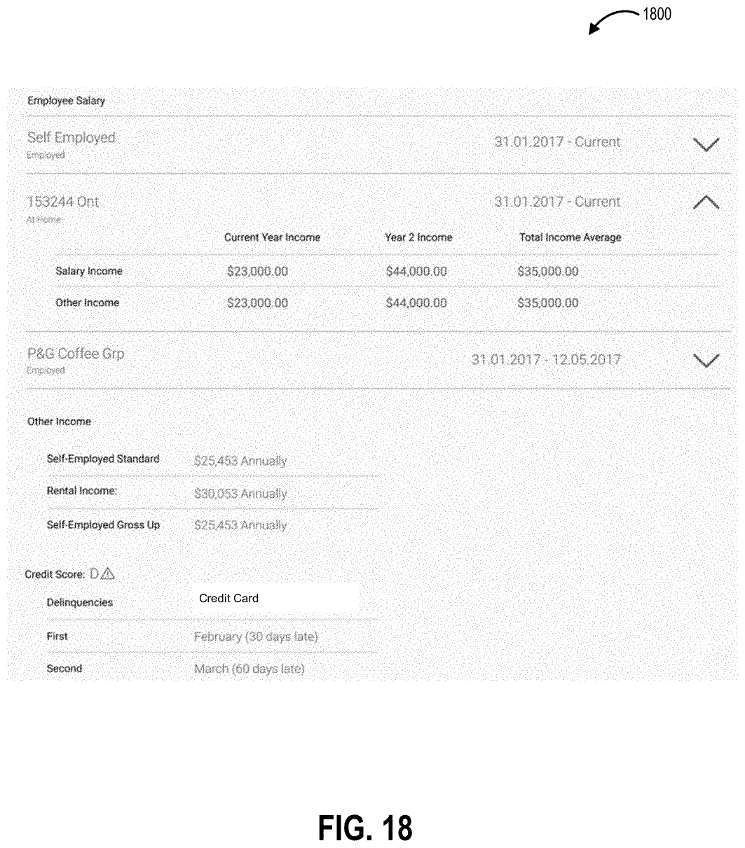

Reference is made to FIG. 18, which illustrates a graphical user interface (GUI) 1800 providing summary details of a resource allocation query, in accordance with an embodiment of the present disclosure. For example, the summary details may include occupation data, income source data over time, credit bureau data including data associated with delinquent or late payments.

Embodiments of graphical user interfaces disclosed herein may display a resource allocation prediction and associated data values of feature attributes for providing interpretative analytical data, such that a mortgage adjudicator user of the present disclosure may readily identify feature attributes that may impact a resource allocation prediction.

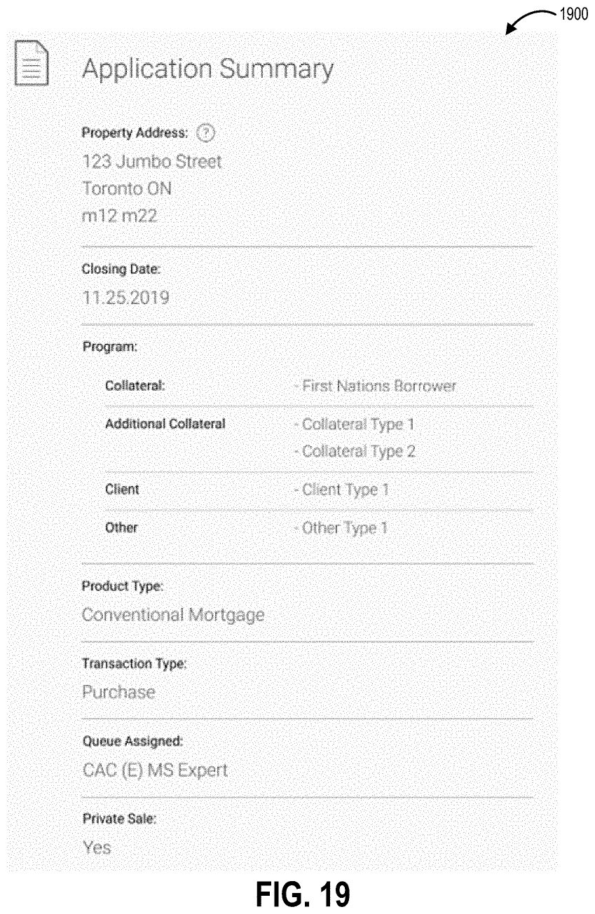

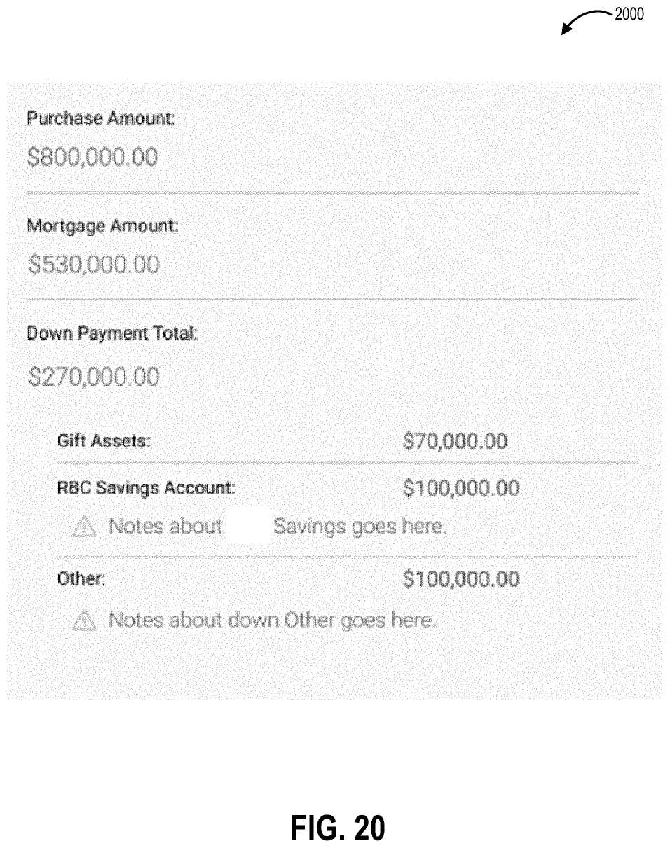

Reference is made to FIGS. 19 and 20, which illustrate graphical user interfaces (1900, 2000) providing summary details of a resource allocation query, in accordance with embodiments of the present disclosure. Continuing with examples described herein, the resource allocation query may be represented as a data record associated with a mortgage loan application. Other types of queries may be contemplated.

In FIG. 19, the GUI 1900 provides a summary of data values associated with data fields relating to real estate property from which a mortgage loan may be secured (e.g., asset-secured resource loan). In FIG. 20, the GUI 2000 provides a summary of data values relating to purchase price data and data values relating to sources of other resources (e.g., currency) for a mortgage down payment.

The graphical user interfaces illustrated in FIGS. 18, 19, and 20 may be target data provided by a resource allocation query (e.g., mortgage loan application). The target data may be associated with a plurality of feature attributes relating to generating a resource allocation prediction. Embodiments of the graphical user interfaces may provide a user of the client device 130 (FIG. 1) or a user of the system 100 (FIG. 1) with an aggregate user interface to view target data that may be relevant to resource allocation events. For instance, the target data may include data values associated with a resource allocation requester (e.g., mortgagee), assets, capacity to re-pay loaned resources, credit history, collateral or property against which a resource allocation may be secured, or other data values associated with feature attributes described in examples of the present disclosure.

Several examples described herein for describing embodiments of the present disclosure may relate to mortgage loan applications (e.g., loaning currency). It may be appreciated that other resource loan queries may be contemplated. For example, embodiments of the present disclosure may be provided for resource loan queries for other types of resources, such as computing resources, precious metals, digital assets, or other types of assets.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

What is claimed is:

1. A system for machine learning architecture for resource allocation comprising:
a processor;
a memory coupled to the processor and storing processor-executable instructions that, when executed, configure the processor to:
receive a resource allocation query including target data associated with a plurality of feature attributes related to generating a resource allocation prediction;
generate the resource allocation prediction based on an allocation model and the target data, the allocation model defined by at least one conditional distribution representation for providing an interim prediction corresponding to one or more feature attributes, and wherein the resource allocation prediction is generated based on a combination of conditional distribution representations respectively correlated with other conditional distribution representations by a hierarchical relation; and
transmit a signal representing the resource allocation prediction for display on a user interface.

2. The system of claim 1, wherein the processor-executable instructions, when executed, configure the processor to:
determine that the resource allocation query includes at least one unavailable data value associated with a given feature attribute; and
prior to generating the resource allocation prediction, generate an imputed data value in place of the unavailable data value based on a conditional distribution representation associated with the given feature attribute, the conditional distribution representation associated with the given feature attribute is based on historical data values of the given feature attribute.

3. The system of claim 2, wherein the processor-executable instructions, when executed, configure the processor to:
generate an imputed confidence value associated with the resource allocation prediction based on the imputed data value;
and wherein transmitting the signal representing the resource allocation prediction includes transmitting the imputed confidence value with the resource allocation prediction.

4. The system of claim 1, wherein the resource allocation prediction includes a quantity of resources to be allocated.

5. The system of claim 1, wherein the processor-executable instructions, when executed, configure the processor to:
receive a signal representing an explanation query associated with at least one queried feature attribute; and
generate a signal representing an explanation representation based on a conditional distribution representation corresponding to the at least one queried feature attribute for indicating a confidence measure corresponding to the resource allocation prediction.

6. The system of claim 5, wherein the signal representing the explanation query is associated with two queried feature attributes, and wherein the signal representing the explanation representation is for displaying a two-dimensional heat map associated with the two queried feature attributes.

7. The system of claim 1, wherein the resource allocation prediction is based on a Bernoulli distribution, the Bernoulli distribution based on the combination of conditional distribution representations.

8. The system of claim 1, wherein the at least one conditional distribution representation includes a Dirichlet distribution defined based on at least one other conditional distribution representation correlated by a hierarchical relation and historical data values corresponding to feature attributes.

9. The system of claim 1, wherein the at least one conditional distribution representation includes a Gaussian distribution defined based on a mean of weighted data values associated with a feature attribute of the historical resource allocation data set.

10. The system of claim 1, wherein the hierarchical relation corresponds to a genus-species relation among a plurality of feature attributes associated with the at least one conditional distribution representations.

11. A method for machine learning architecture for resource allocation comprising:
receiving a resource allocation query including target data associated with a plurality of feature attributes related to generating a resource allocation prediction;
generating the resource allocation prediction based on an allocation model and the target data, the allocation model defined by at least one conditional distribution representation for providing an interim prediction corresponding to one or more feature attributes, and wherein the resource allocation prediction is generated based on a combination of conditional distribution representations respectively correlated with other conditional distribution representations by a hierarchical relation; and
transmitting a signal representing the resource allocation prediction for display on a user interface.

12. The method of claim 1, comprising:
determining that the resource allocation query includes at least one unavailable data value associated with a given feature attribute; and
prior to generating the resource allocation prediction, generating an imputed data value in place of the unavailable data value based on a conditional distribution representation associated with the given feature attribute, the conditional distribution representation associated with the given feature attribute is based on historical data values of the given feature attribute

13. The method of claim 12, comprising:
generating an imputed confidence value associated with the resource allocation prediction based on the imputed data value;
and wherein transmitting the signal representing the resource allocation prediction includes transmitting the imputed confidence value with the resource allocation prediction.

14. The method of claim 11, wherein the resource allocation prediction includes a quantity of resources to be allocated.

15. The method of claim 11, comprising:
receiving a signal representing an explanation query associated with at least one queried feature attribute; and
generating a signal representing an explanation representation based on a conditional distribution representation corresponding to the at least one queried feature attribute for indicating a confidence measure corresponding to the resource allocation prediction.

16. The method of claim 15, wherein the signal representing the explanation query is associated with two queried feature attributes, and wherein the signal representing the explanation representation is for displaying a two-dimensional heat map associated with the two queried feature attributes.

17. The method of claim 11, wherein the resource allocation prediction is based on a Bernoulli distribution, the Bernoulli distribution based on the combination of conditional distribution representations.

18. The method of claim 11, wherein the at least one conditional distribution representation includes a Dirichlet distribution defined based on at least one other conditional distribution representation correlated by a hierarchical relation and historical data values corresponding to feature attributes.

19. The method of claim 11, wherein the hierarchical relation corresponds to a genus-species relation among a plurality of feature attributes associated with the at least one conditional distribution representations.

20. A non-transitory computer-readable medium or media having stored thereon machine interpretable instructions which, when executed by a processor, cause the processor to perform a computer-implemented method for machine learning architecture for resource allocation, the method comprising:
receiving a resource allocation query including target data associated with a plurality of feature attributes related to generating a resource allocation prediction;
generating the resource allocation prediction based on an allocation model and the target data, the allocation model defined by at least one conditional distribution representation for providing an interim prediction corresponding to one or more feature attributes, and wherein the resource allocation prediction is generated based on a combination of conditional distribution representations respectively correlated with other conditional distribution representations by a hierarchical relation; and
transmitting a signal representing the resource allocation prediction for display on a user interface.
